(19) United States
(12) Patent Application Publication
(10) Pub. No.: US 2017/0092151 A1
(43) Pub. Date: Mar. 30, 2017

(54) SECOND LANGUAGE INSTRUCTION SYSTEM AND METHODS

(71) Applicants: Wei Xi, New York, NY (US); Rui Huang, Beijing (CN)

(72) Inventors: Wei Xi, New York, NY (US); Rui Huang, Beijing (CN)

(21) Appl. No.: 14/864,370

(22) Filed: Sep. 24, 2015

(51) Int. Cl. G09B 19/06; G09B 5/06; G09B 7/00

(52) U.S. Cl. CPC G09B 19/06; G09B 7/00; G09B 5/06

(57) ABSTRACT

A second language instruction system enabling a user to learn a second language through one or more life-like scenarios in a virtual world. The second language instruction system includes a computing device in electrical communication with a server via a network, the computing device is configured to assess the second language abilities of the user, receive one or more scenario preferences of the user, and generate a customized learning syllabus at least partially based on the assessed second language abilities of the user and the received one or more scenario preferences of the user, portions of the customized learning syllabus are downloaded for use and deleted after completion to minimize the amount of data stored on the computing device.

### TECHNICAL FIELD

The present disclosure relates generally to a second language instruction system and method. More particularly, the present disclosure relates to a system and method for learning a second language through a series of practical, life-like scenarios tailored to match the student's second language abilities and preferences.

### BACKGROUND

Studies have shown that one of the most effective methods for learning a second language is to merge teaching activities into typical language communication activities common in daily life. This is often referred to as “learning by doing”. Conventional second language teaching systems fail in this regard. For example, although some systems may provide a background context for learning particular tasks, generally the core interactive mechanism consists of merely memorizing words, sentences and eventually pre-designed dialogues and phrases. This method of teaching, however, is removed from real-life communication, which is not limited to a series of specific pre-designed phrases. Rather, in real-life, an idea is often communicated through a variety of phrases or gestures that in effect all mean the same thing. Therefore, simply learning how to speak and understand pre-designed phrases has limited usefulness in the real world.

Conventional systems that do provide more life-like simulation drills suffer from a one-size fits all set of scenarios. Even where the learning content is aimed at particular occupations or age groups, conventional systems fail to account for the fact that second language students come from a wide variety of backgrounds and are often learning a second language for different reasons. For example, one student may want to use a second language to be able to order food, or to greet international visitors, while another student may want to learn a second language for business purposes. Additionally, second language students often vary significantly in their ability to absorb and retain the second language. Therefore, having a one-size fits all set of scenarios for all students, rarely fits any one student correctly.

Moreover, there is generally a significant gap between the rote memorization and the life-like simulation drills. In particular, conventional systems typically lack any assisting mechanism to help learners transfer the language skills that they have learned in the memorization stage to the real-life scenario stage. The end result from such conventional systems is repetition of material already known to the student, spending significant amounts of time on scenarios that may not be applicable to the student or that the student is not interested in learning, and producing a second language knowledge base that is limited to a set of pre-designed phrases.

A progressive interactive second language instruction system and method configured to provide a series of practical, real-life scenarios tailored to match each particular student's second language abilities and preferences would provide significant advantages.

### SUMMARY OF THE DISCLOSURE

Embodiments of the present disclosure address the need for a progressive interactive second language instruction system and method for learning a second language through a series of practical, life-like scenarios, also known as interactive simulation tasks, tailored to match each student's second language abilities, as well as their goals or preferences in learning the second language. For example, if student A is a businessman who has had little exposure to the second language, but is concerned about making a good first impression to his international counterparts, the progressive interactive second language instruction system can generate a customized learning syllabus for learner A that includes one or more interactive simulation tasks tailored to various introductory greetings at a basic skill level. In another example, if student B is conversational in the second language, but is interested in improving her negotiating skills, the system can generate a customized learning syllabus for learner B that includes interactive simulation tasks tailored to various advanced level negotiations. In this way, embodiments of the present disclosure provide a more efficient way of learning a second language by generating “learning by doing” exercises through interactive simulation tasks that are specifically tailored to an individual student's abilities and interests.

One embodiment of the present disclosure comprises a second language instruction system enabling a user to learn a second language through life-like scenarios in a virtual world. In this embodiment, the second language instruction system can include a computing device in electrical communication with a server via a network. The computing device can include a language skills assessment module configured to assess the second language abilities of the user, and a customization module configured to receive one or more scenario preferences of the user.

The customization module can further be configured to generate a customized learning syllabus, at least partially based on the assessed second language abilities of the user. The customized learning syllabus can include an interaction portion in which the user is required to navigate around a virtual world to interact with virtual characters in one or more life-like scenarios selected based on the received one or more scenario preferences of the user.

In one embodiment, the second language instruction system can further include a virtual venues management module configured to download the one or more life-like scenarios from the server to the computing device on demand, and remove the one or more life-like scenarios from the computing device after completion. This enables the virtual venues management module to continuously minimize the amount of data stored on the computing device for the purpose of enabling the computing device to operate at faster speeds, without being inhibited by a full memory or restricted by the storage of unused portions of the system in the computing device's memory.

In one embodiment, the customization module can further be configured to provide a compulsory learning syllabus when the user has no experience in the second language. In one embodiment, the customization module can further be configured to identify duplicate and previously completed portions in the customized learning syllabus.

In one embodiment, the customized learning syllabus can include an interaction portion in which the user is required to navigate around a virtual world to interact with virtual characters in life-like scenarios selected based on the scenario preferences of the user. For example, in some embodiments, the virtual world can be representative of the real-world and include stores and restaurants along one or more roads. In one embodiment, the user can design their own avatar a virtual character to navigate around the virtual world.

In some embodiments, the learning syllabus can also include a non-life-like portion. In one embodiment, the non-life-like portion is generated based on the scenario preferences of the user, observations made during of completion of the one or more life-like scenarios, and a combination thereof. Further, in some embodiments, the user can switch between the life-like portions and the non-life-like scenarios, as well as participating in the test taking portions of the customized learning syllabus. In one embodiment, the non-life-like portion can be generated based on the selection of the life-like portions. In one embodiment, both the life-like and non-life-like portions can include testing portions that require the user to successfully complete one or more tasks.

In one embodiment, the customized learning syllabus can include a listening portion, a speaking portion, a conversational portion, and a core task portion. The core task portion can include greeting another person, being introduced to another person, introducing another person, buying food, buying clothes, eating in a restaurant, making an appointment, changing an appointment, asking for directions, giving directions, specifying destinations, and handling an emergency. Further, the customized learning syllabus can incorporate a hint-and-assistance module configured to provide assistive information to the user.

In one embodiment, the first embodiment further includes a virtual venue management module configured to download life-like scenarios from the server to the computing device, and then remove them from the computing device after completion, for the purpose of minimizing the amount of data stored on the computing device, so that the computing device can run without being inhibited or hindered by the retention of unused portions of the second language instruction system stored in the computing device's memory.

In one embodiment, the first embodiment can also comprise a user management module configured to store personal information for the user. In some embodiments, this can include user preferences for visual elements. The user management module can also be configured to record a learning history of the user and generate feedback to the user based on the learning history. In one embodiment, the learning history can include observations made during of completion of the customized learning syllabus. The learning history can further include voice samples collected from the user via a microphone.

One embodiment further comprises a peer-to-peer interactive task module configured to enable a user to connect with another user to complete peer-to-peer task portions. The peer-to-peer interactive task module can be configured to match one user with another user based on their respective second language abilities and scenario preferences. Further, the peer-to-peer interactive task module can include a microphone configured to enable voice communication and a camera configured to enable video communication. In another embodiment, additional users can join an ongoing peer-to-peer interaction portion between two users.

One embodiment of the disclosure further provides for a method of providing second language instruction through life-like scenarios in a virtual world. In some embodiments, the method can include assessing second language abilities of a user, receiving scenario preferences of the user and generating a customized learning syllabus at least partially based on the assessed second language abilities of the user. In some embodiments, the customized learning syllabus can include an interaction portion in which the user is required to navigate around a virtual world to interact with virtual characters in one or more life-like scenarios selected based on the received one or more scenario preferences of the user. In some embodiments, the method further includes downloading life-like scenarios from a server to a computing device and removing them from the computing device after completion, for the purpose of minimizing the amount of data stored on the computing device.

Another embodiment of the present disclosure provides a second language instruction system enabling remote, network based peer-to-peer communications among users with compatible second language abilities through life-like scenarios tailored to match a user's preference. In this embodiment, the second language instruction can comprise a first computing device associated with a first user in electrical communication with a second computing device associated with a second user via a network. The first computing device can be programmed to assess the second language abilities of the first user, receive one or more scenario preferences of the first user, and generate a customized learning syllabus including a peer-to-peer interaction portion in which the first user is matched to the second user for remote communication, based on the assessed second language abilities of the first user and the received one or more scenario preferences of the first user.

In one embodiment, the customized learning syllabus can introduce one or more language parts to the first user, and require that the first user to complete at least one interactive simulation task using a portion of said one or more language parts in a life-like scenario during the peer-to-peer interaction portion.

In one embodiment, the first user can switch between the introduction of one or more language parts and the at least one interactive simulation task after beginning the at least one interactive simulation task.

In one embodiment, the first computing device is further programmed to store personal preference information of the first user, including one or more preferences for the presentation of the one or more language parts.

In one embodiment, the received one or more scenario preferences include a preference for life-like scenarios, which may relate to one of ordering food, shopping, asking for help, getting directions, making an informal introduction, making a formal business introduction, conducting a business meeting, and a combination thereof.

In one embodiment, first user is assigned a role to play in a life-like scenario during the peer-to-peer interaction portion.

In one embodiment, the life-like scenario includes one or more task goals. In one embodiment, the computing device is further programmed to record a pass or fail status for the life-like scenario, based on completion of the one or more task goals.

In one embodiment, the first computing device further includes a global positioning unit configured to determine the location of the first user. In one embodiment, the first user is further matched to the second user for peer-to-peer interaction, based at least in part on the location of the first user. In one embodiment, a life-like scenario during the peer-to-peer interaction portion is selected based at least in part on the location of the first user.

In one embodiment, the first user is provided a plurality of matched potential users from whom the first user can select as the second user for the peer-to-peer interaction portion. In one embodiment, the first user is provided basic information for each of the matched potential users to aid in the selection of the second user.

In one embodiment, the peer-to-peer interaction includes voice communication between the first user and the second user. In one embodiment, the peer-to-peer interaction includes video communication between the first user and the second user. In one embodiment, the peer-to-peer interaction portion is recorded and stored for later playback.

In one embodiment, the first user is a second language learner and the second user is an instructor. In one embodiment, the first user is matched with the instructor when the assessed second language abilities of the first user indicate that the first user has a vocabulary of less than 500 words in the second language. In one embodiment, the first user is matched with a student as the second user when the assessed second language abilities of the first user indicate that the first user has a vocabulary of 500 or more words in the second language.

In one embodiment, additional users can join an ongoing peer-to-peer interaction portion between a first user and a second user.

Another embodiment of the present disclosure provides second language instruction system, which can include computing hardware, including a processor, a data storage device, and a graphical user interface, one or more input/output devices, an audio input device and an audio output device. In this embodiment, the second language instruction system can include instructions executable on the computing hardware and stored in a non-transitory storage medium comprising a study management and support subsystem. In one embodiment, the syllabus customization module can be configured to assess a level of language skill of a learner in a target language, receive one or more learning preferences of the learner, and generate, based on the level of language skill and at least one of the one or more learning preferences, a customized learning syllabus including at least one interactive simulation task. In one embodiment, the learning module can be configured to execute the customized learning syllabus. In one embodiment, the learning module can include one or more target language modules configured to introduce one or more language parts to the learner, and one or more interactive simulation task modules configured to require the learner to complete the at least one interactive simulation task.

In one embodiment, the study management and support subsystem can further comprise a user management module configured to store personal information for a learner, including one of more learner preferences for visual elements.

In one embodiment, the user management module can further be configured to record a learning history of the learner, and generate, using the learning history, feedback and one or more recommendations for one or more skill training game modules to the user.

In one embodiment, the system further includes a system improvement subsystem. The system improvement subsystem can include a voice samples collection module configured to collect one or more voice samples from the learner, and a special learning needs collection module configured to collect one or more learning needs from the learner.

In one embodiment, the study management and support subsystem can further include a hint and assistance module configured to provide, to the learner, information regarding the current task.

In one embodiment, the syllabus customization module can further be configured to provide a compulsory learning syllabus when the learner has no experience in the target language.

In one embodiment, the syllabus customization module can further be configured to identify duplicate tasks in the customized learning syllabus.

In one embodiment, the syllabus customization module can further be configured to identify tasks that the learner has already completed.

In one embodiment, the one or more of the one or more target language modules can be associated with one or more of the one or more interactive simulation task modules, such that the learning modules subsystem can be further configured to enable the learner to switch between associated target language modules and interactive simulation task modules.

In one embodiment, each of the one or more interactive simulation task modules can be selected from at least one of listening tasks, speaking tasks, conversational tasks, core tasks, and a combination thereof.

In one embodiment, each of the one or more interactive simulation task modules can further be configured to provide a practice mode wherein the learner can attempt to complete the one or more tasks, and provide a test mode wherein the learner must complete the one or more tasks.

In one embodiment, each of the one or more simulation task modules can further be configured to record a pass or fail status for each of the one or more tasks for each learner.

In one embodiment, each of the one or more interactive simulation task modules can further be configured to generate a random plan for each of one or more rounds of the one or more tasks. In one embodiment, each of the one or more interactive simulation task modules is further configured to generate a random response for each one or more steps of the one or more rounds.

In one embodiment, the random response can be an audio output. In one embodiment, the speaking task module can be configured to enable the learner to provide input via at least one of word cards, typing, voice input, and a combination thereof.

In one embodiment, the system further includes one or more peer-to-peer simulation task modules configured to enable more than one peer-to-peer user to interact in order to complete one or more tasks. In one embodiment, the one or more peer-to-peer simulation task modules can be configured to enable a peer-to-peer user to interact with other peer-to-peer users to complete a peer-to-peer simulation task simultaneously.

In one embodiment, the learning modules subsystem is organized by one or more target learner types and one or more language difficulty levels.

One embodiment of the disclosure provides a method of providing second language instruction including assessing a level of language skill of a learner in a target language, receiving one or more learning preferences of the learner, generating, based on the level of language skill and at least one of the one or more learning preferences, a customized learning syllabus having one or more interactive simulation task modules, introducing one or more language parts to the learner, and requiring the learner to complete the one or more interactive simulation task modules.

The summary above is not intended to describe each illustrated embodiment or every implementation of the present disclosure. The figures and the detailed description that follow more particularly exemplify these embodiments.

### BRIEF DESCRIPTION OF THE DRAWINGS

FIG. 1 is a block diagram depicting components of a second language instruction system and method in accordance with an embodiment of the disclosure.

FIG. 2 is a block diagram depicting a user database and learning components database in accordance with an embodiment of the disclosure.

FIG. 3 is a table depicting a hierarchy of a target language database in accordance with an embodiment of the disclosure.

FIG. 4 is a flowchart depicting a method for student to customize a learning syllabus in accordance with an embodiment of the disclosure.

FIG. 5 is a flowchart depicting operation of a learning module subsystem in accordance with an embodiment of the disclosure.

FIG. 6 is a flowchart depicting operation of an interactive simulation tasks module in accordance with an embodiment of the disclosure.

FIG. 7 is a data flow diagram depicting modules within a listening task module, as well as a flow of information and data stores that serve as inputs and outputs in accordance with an embodiment of the disclosure.

FIG. 8 is a data flow diagram depicting inputs and outputs to a random plan generator module, as well as processing components and data stores used by a listening task module and a speaking task module in accordance with an embodiment of the disclosure.

FIG. 9 is a data flow diagram depicting components of a listening task input manager module and processing components within an agent action manager module, as well as input and output relations among a listening task input manager module, an agent action manager module and a user agent module in accordance with an embodiment of the disclosure.

FIG. 10 is a data flow diagram depicting inputs and outputs to a Non-Player Character (NPC) action management module and processing components to control an NPC within any type of interactive simulation task module in accordance with an embodiment of the disclosure.

FIG. 11 is a data flow diagram depicting inputs and outputs to a task status monitor module, and processing components and data stores used by any type of interactive simulation task module in accordance with an embodiment of the disclosure.

FIG. 12 is a data flow diagram depicting inputs and outputs to a listening task results feedback module, as well as processing components and data stores used by a listening task module in accordance with an embodiment of the disclosure.

FIG. 13 is a data flow diagram depicting modules implementing a speaking task, as well as a flow of information and data stores serving as inputs and outputs in accordance with an embodiment of the disclosure.

FIG. 14 is a data flow diagram depicting inputs and outputs to a speaking task input manager module, as well as processing components and data stores used by a speaking task in accordance with an embodiment of the disclosure.

FIG. 15 is a data flow diagram depicting inputs and outputs to a speaking task results feedback module, as well as processing components and data stores used by a speaking task in accordance with an embodiment of the disclosure.

FIG. 16 is a data flow diagram depicting modules implementing a conversational task and a flow of information and data stores that serve as inputs and outputs in accordance with an embodiment of the disclosure.

FIG. 17 is a data flow diagram depicting inputs and outputs to a random response generator module and an elements temporary storage module, as well as processing components and data stores used by conversational task, core task and peer-to-peer interactive task in accordance with an embodiment of the disclosure.

FIG. 18 is a data flow diagram depicting inputs and outputs to a bidirectional input manager module, as well as processing components and data stores used by a conversational task and a core task in accordance with an embodiment of the disclosure.

FIG. 19 is a data flow diagram depicting inputs and outputs to a conversational audio management module, as well as processing components and data stores used by a conversational task, a core task and a peer-to-peer interactive task in accordance with an embodiment of the disclosure.

FIG. 20 is a data flow diagram depicting inputs and outputs to a bidirectional task results feedback module with processing components and data stores used by a conversational task, a core task and a peer-to-peer interactive task, together with messages and data exchanged among them in accordance with an embodiment of the disclosure.

FIG. 21 is a data flow diagram depicting modules within a core task with a flow of information and data stores that serve as inputs and outputs, together with user who interact with the module in accordance with an embodiment of the disclosure.

FIG. 22 is a data flow diagram depicting inputs and outputs to a user Do-It-Yourself (DIY) generator module with processing components and data stores used by core task and peer-to-peer interactive task in accordance with an embodiment of the disclosure.

FIG. 23 is a data flow diagram depicting module within a peer-to-peer interactive task with a flow of information and data stores that serve as inputs and outputs in accordance with an embodiment of the disclosure.

FIG. 24 is a data flow diagram depicting inputs and outputs to choose and activate skill training games modules in accordance with an embodiment of the disclosure.

FIG. 25 is a data flow diagram depicting procedure of users' learning tasks alarm system, as well as a flow of information and data stores that serve as inputs and outputs, together with user who interact with the module in accordance with an embodiment of the disclosure.

FIG. 26 is a data flow diagram depicting procedure for learners to find peer-to-peer interactive task counterpart with processing components and data stores that serve as inputs and outputs together with users who interact in accordance with an embodiment of the disclosure.

FIG. 27 depicts the layout and sample contents of target realms and target tasks for students of the learning choices module in accordance with an embodiment of the disclosure.

While embodiments of the disclosure are amenable to various modifications and alternative forms, specifics thereof are shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure as defined by the appended claims.

### DETAILED DESCRIPTION

Embodiments of the disclosure relate to a system and method for interactive second language instruction. As will be described in further detail below, using the disclosed embodiments, students or users can gradually learn communication skills with a second language both in oral and written form, in order to communicate with native speakers and others learning the second language. Communicative language skills can include listening, speaking, reading and writing. Other communicative knowledge can also be included, for example, culture, local customs, and notable sights of the target countries can be included.

Any language can be taught as a second language to users, such as English, Chinese, German, Spanish, and French. As used herein: a “target language” is a second language that a user wishes to learn; a “learner” is a student or person learning a target language in most of the learning task modules; and a “user” is a learner, or an instructor interacting with a learner, for example, in a peer-to-peer interactive task module.

Learners can be of any age. Learners can possess various levels of second language ability ranging from beginners with no prior second language experience to experienced second language speakers. Learners can have various learning goals, such as curriculum learning, business purposes, living or preparing to live in a country in which the target language is a native language, or short-term travelling.

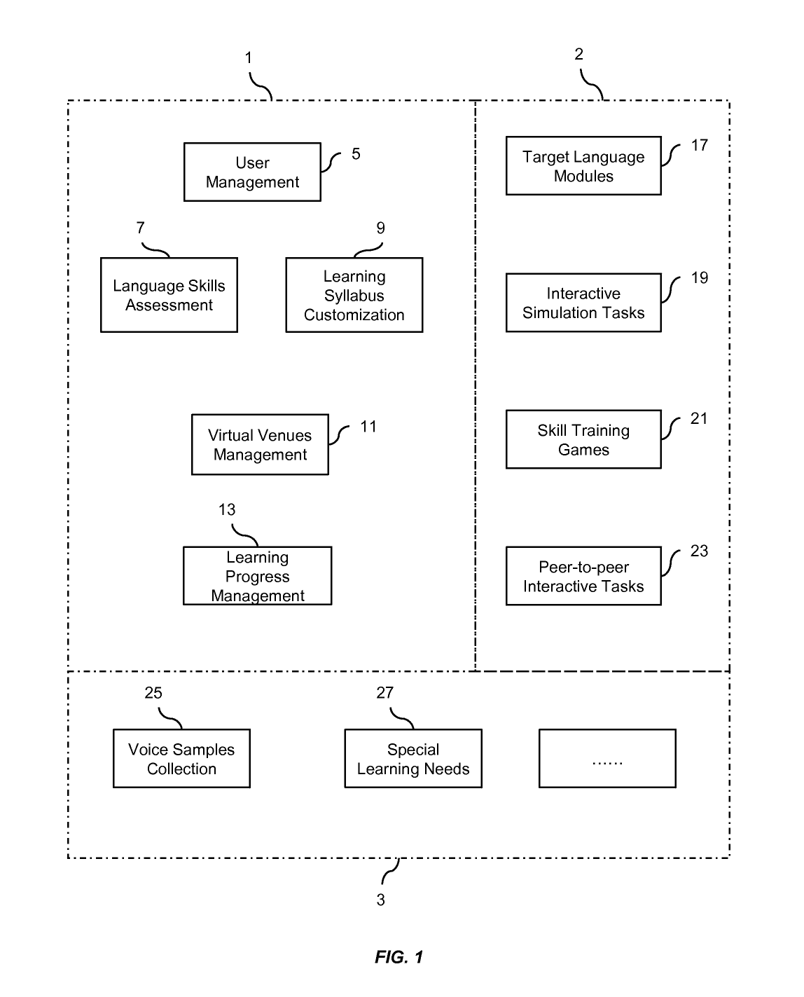

Referring to FIG. 1, components for implementation of a second-language instruction system and method according to one embodiment are depicted. Second-language instruction system 100 system can be composed of three subsystems: a study management and support subsystem 1, a learning modules subsystem 2, and a software improvement subsystem 3.

Study management and support subsystem 1 can contain five modules. User management module 5 can manage user information. User information can include user login and password information, user history and status, and custom elements. Custom elements can include customized—also known as Do-It-Yourself (DIY)—user agents that enable users to choose body features, clothes, and other configuration options.

Language skills assessment module 7 can provide evaluation of a learner's current language skills. Evaluation can be based on one or more second-language skill rubrics applied to a target language. Second-language skill rubrics can be industry standard rubrics or custom developed. An evaluation report can be generated by comparing learner's task performance score (according to the rubric) with the highest score requirements in the rubric. Language skills assessment module 7 can be accessed for first-time learners if they are not at a beginner level or have some prior language skills. It can also be accessed by learners when customizing a learning syllabus for a new learning period as needed.

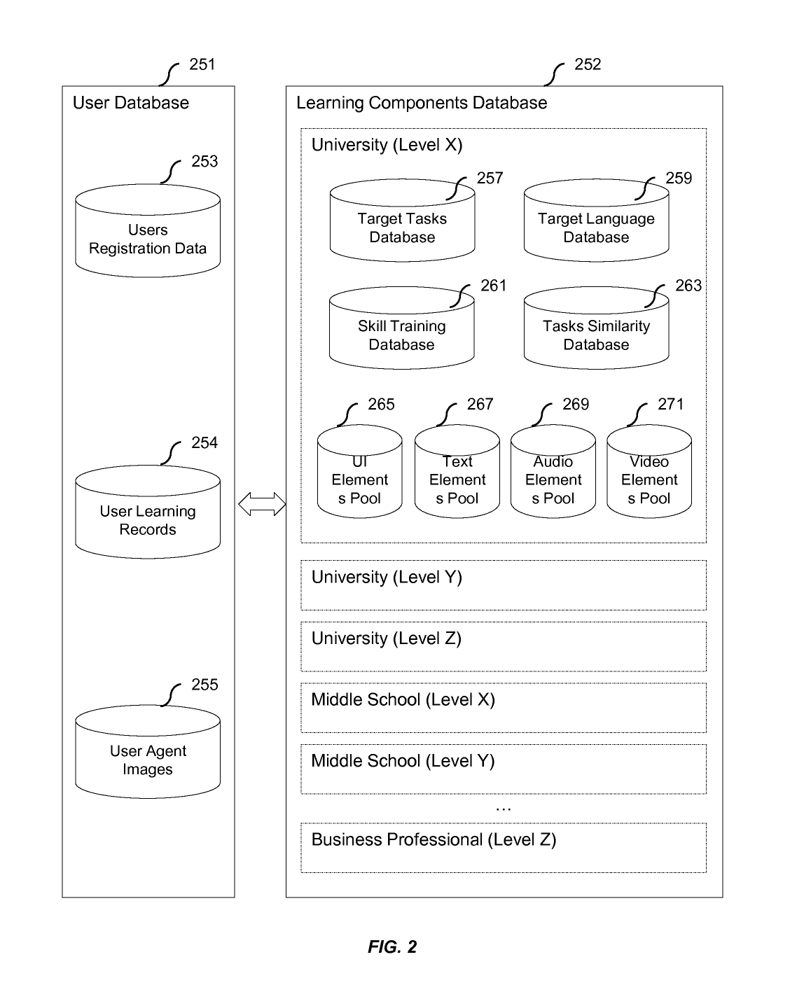

Learning syllabus customization module 9 can be accessed by all learners at the beginning of each learning period to generate a learning syllabus based on the users' learning needs and priorities, language level and learning history. Learning syllabus customization module 9 can provide a compulsory learning syllabus 29 or a tailor-made learning syllabus 43. For greater detail, see FIG. 2 and accompanying text. A syllabus can be a learning plan for a period of time. Each syllabus can include a listing and ordering of lessons to take, and within each lesson can be one or more specific tasks for the learner. Tasks can be marked as “testing” or exam tasks, for example, if the learner has completed the task previously. If a learner has completed an exam task, the learner can avoid re-learning the content for the task if it is assigned in a syllabus later.

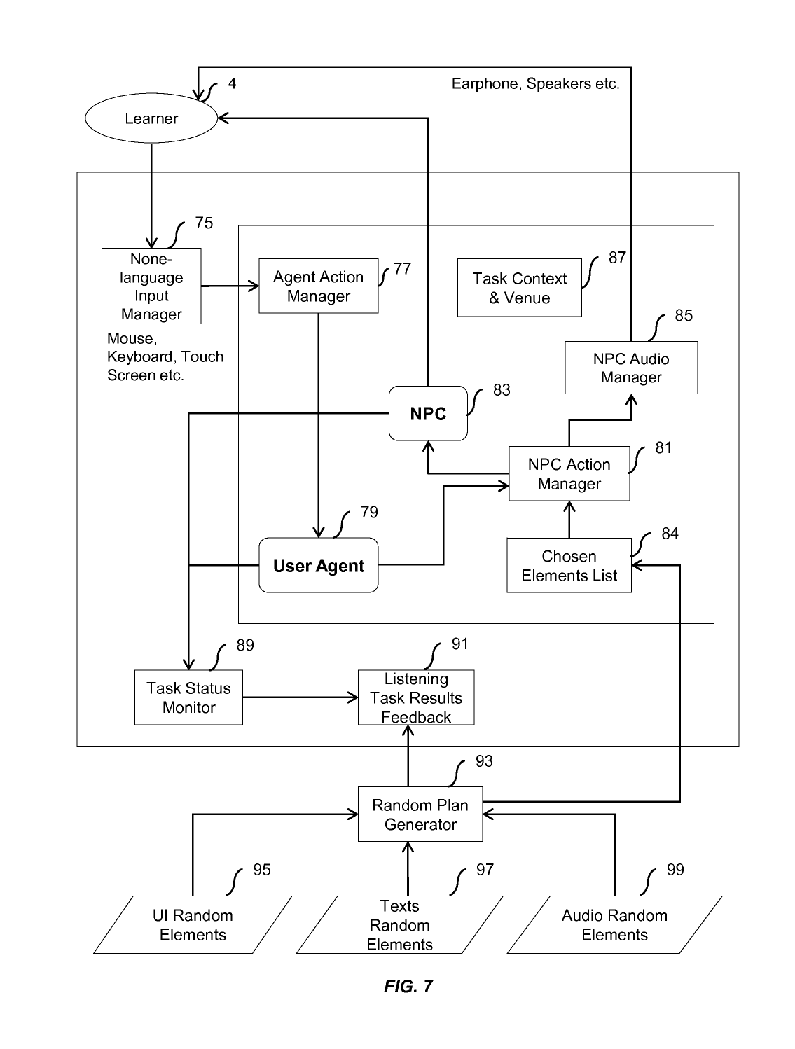

Virtual venues management module 11 can provide an overall system interface that can be designed as a virtual society, including a “training camp” and various venues where interactive simulation tasks can take place. All venues can be linked to one or more tasks. Intensive skill training games can be located in the training camp. Virtual venues management module 11 can restrict access to venues to only those needed by activated learning modules which can be linked to the corresponding task context and venue 87. For greater detail, see FIG. 7 and accompanying text. The venues associated with deactivated learning modules can be viewable by learners, but links to learning modules are generally not available.

Learning progress management module 13 can activate or deactivate learning modules and tasks based on a learner's syllabus and learning history. Learning modules and tasks that are not activated are generally not accessible to the learner. Such access can discourage account sharing between learners. Generally, only one learning module and task are activated. However, if a skill training game is activated, the associated target language module can be activated as well. Learning modules can also remain deactivated until the learner has completed any prerequisite modules dictate by the learner's syllabus.

Learning system 2 can comprise four modules. Target language module 17 can be provided in “training camp” for their pre-task preparation on new language materials when activated by learning progress management module 13.

Interactive simulation tasks module 19 can provide simulation tasks after learners complete pre-task language module preparation using target language modules 17.

Skill training games module 21 can be activated by learning progress management module 13 based on learner's performance in interactive simulation tasks module 19 in order for learners to perform focused practice on pronunciation, spelling, vocabulary, or sentences.

Peer-to-peer interactive tasks module 23 can provide further interactive tasks at the end of each lesson if selected by the learner or recommended by learning progress management module 13. Users can use the user management 5 to schedule one or more counterparts, for example, an instructor or other learner, to complete corresponding peer-to-peer interactive tasks.

Software improvement system 3 can contain several modules which can be augmented as the system upgrades. Voice samples collection module 25 can gather user's voice files from audio sequenced storage module 141 and conversational audio management module 191 (as discussed below) in order to analyze and improve the voice recognition quality. This is a benefit because for various ethnic groups, the voice recognition parameters can be different. For example, pronunciation errors caused by English speaking users can be significantly different from those caused by Japanese users. Therefore, more ethnically diversified acoustic models are important to speech recognition of second language speakers. Voice samples collection module 25 can accumulate non-native acoustic samples and segment them according to nation or native language.

Special learning needs module 27 can be deployed to gather information on a users' learning needs if they are not already covered in target tasks database 257 or target language database 259 (as discussed below), so as to better suit individual's learning needs.

Components of second-language instruction system 100 system can accept user inputs via keyboard, mouse, touch screen or other input methods. User management system can display outputs to a user via local display, remote display, network, audio outputs, or any other output method.

Referring to FIG. 2, a diagram of the underlying storage system according to an embodiment is depicted. In one embodiment, the underlying storage system includes types of databases and their elements, as well the interconnections among the components. The backend database can be stored on a local server, on a network, remotely in a cloud configuration, or other configuration or combination thereof. The backend database can be divided into two categories: user database 251 and learning components database 252. User database 251 can contain various sub-databases, such as user registration data 253, user learning records 254, user agent images 255, or a combination thereof.

In learning components database 252, databases can be first organized by various target learner types/groups, such as university students, high school students, middle school students, elementary students, business adults, or business professionals. Each target learner type can then have various learning level packages, from a beginning level to an advanced level. Other organization hierarchies can of course be utilized. Within each level of a certain learner type, various databases can be created, such as a target tasks database 257, target language database 259, skill training database 261, tasks similarity database 263, User Interface (UI) elements pool 265, text elements pool 267, audio elements pool 269, and video elements pool 271, or a combination thereof.

The frontend program platform can be web-based, a stand-alone application or other configuration as necessary to enable the user to interact with the system. Data can be transferred between backend and frontend based on the leaner's comprehension or learning status. In other words, only those data and modules needed for the learner's current learning need to be transferred or even stored on user's devices. Alternatively, the general system platform can be first downloaded and installed on user's device, and other data or modules needed for learning can be transferred when a user's device is linked to Internet. Based on the system settings, some learning modules, such as listening tasks, can be downloadable onto the learner's device.

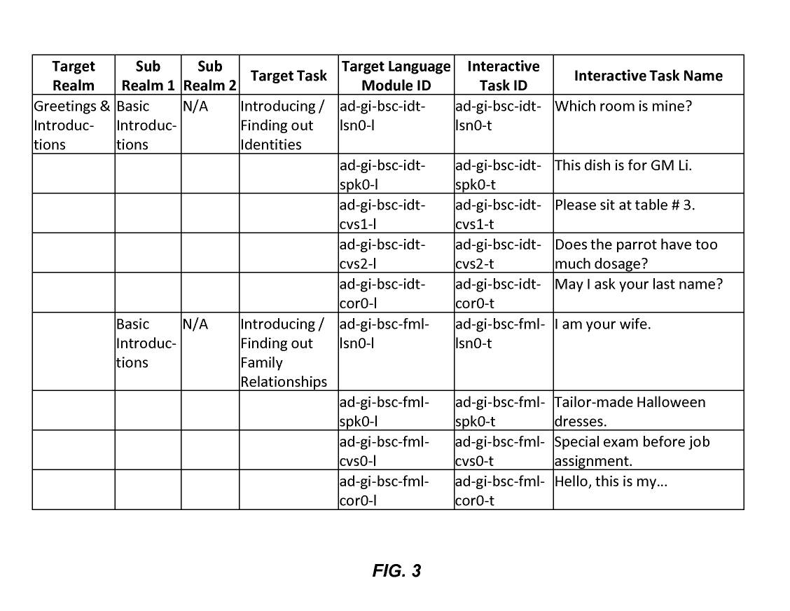

Referring to FIG. 3, a table detailing a hierarchy of a target language database 259 according to an embodiment is depicted. Target language database 259 can be structured with several levels of categories. The first several levels (ideally two to three levels) are target realms 245 with various scales, such as “transportation—directions.” The last level or category is target tasks 247, such as “asking for or giving directions within walking distance.” Under each target task 247 (similar to “lessons”), there can be several target language modules 17 and corresponding interactive simulation tasks 19 listed, including one or more listening tasks 51, one or more speaking tasks 57, one or more conversational tasks 63, one or more core tasks 69, and one or more peer-to-peer interactive tasks 23. All target language modules 17 and interactive simulation tasks 19 can have an ID number, which is unique within each target language database 259 across all target language databases 259 of all levels and all target learners' databases. Different target tasks 247 that contain the same target language modules 17 and same the interactive simulation tasks 19 can be listed with duplicated records. These duplicated records can be updated each time there is a new target task 257 added into the database, and the result can be stored in tasks similarity database 263. Besides the overall database, all unique target language modules 17 are stored in this database.

Target tasks database 257 stores all unique interactive simulation tasks 19 modules that are pre-programmed modules. Text elements pool 267, audio elements pool 269 and video elements pool 271 can be tailored to each interactive simulation task 19, so they can be stored under each interactive simulation task 19 as resources. If text elements, audio elements or video elements are used across multiple tasks, they can be stored in separate databases with relationship data indicating each interactive simulation task 19 along with its text elements, audio elements and video elements.

There are multiple methods of storing UI elements. Because a large amount of UI elements are used across tasks, all UI elements can be stored in UI elements pool 265 with unique UI names. A data form in this database can indicate each interactive simulation task 19 and its needed UI element names. Each time an interactive simulation task 19 is activated UI elements can be loaded into the task module from UI elements pool 265. Alternatively, UI elements needed for each task module can be stored under each interactive simulation task 19 as resources.

Skill training database 261 stores relationship data that shows various skill training game modules and their relationship to: specific language skills, applicable interactive simulation task 19 types, such as a listening task 51, a speaking task 57, a conversational task 63, or core task 69, and task performance scores that can cause the skill training games to be activated.

In operation, each learner's learning syllabus can be developed on a periodic basis, and in each learning period, there can be a certain number of “lessons.” Within each lesson, there can be various types of interactive simulation tasks arranged based on a progressive order of gaining language skills. In one embodiment, the progressive order can be listening tasks, followed by speaking tasks, conversational tasks and core tasks in order. Other orders or arrangements of tasks can be provided. As supplements to the tasks, interactive intensive language Skill Training Games can be suggested to the learners to take as post-task practice. Based on learner's choices, peer-to-peer interactive tasks can be used as supplemental learning as well.

Before each task, learners can use the corresponding target language modules to get familiar with new sentences, words and phrases which are needed as language communication tools to fulfill the task goals, which herein are called “language materials.” These language materials are organized by communication function. Diversified yet commonly used expression sentences for same communication function can also be included in the modules, in order to facilitate users' communication diversities. Within each target language module, grammar, culture, and pronunciation rules can be presented. Pictorial and detailed explanations can apply to new words. Standard audio sounds for new words and sample sentences can apply for learners to practice on pronunciations. The system can recommend learners, or learners can choose to “do task” after a “Target Language Module” is studied.

In one embodiment, target language communication skills can be trained by completing tasks, during which the learners are learning while using the target language as a communication tool. Language materials can be learned by completing interactive simulation listening tasks, speaking tasks and conversational tasks that are called “subtasks” in general. Language materials can be practiced by completing interactive simulation core tasks, as well as peer-to-peer interactive tasks, through which users can be trained to communicate with target language automatically, fluently, accurately and with diversity. Before implementing a new round of core task, learners can create task plans based on their actual needs, and interests, which can increase the simulation's ability to match with their “real life tasks.”

While completing subtasks, learners can be trained in a simulation interactive environment, which leads them to use the language as a means of communication rather than merely learning language structures. Learners will be able to form their sentences automatically using new sentence structures and words that are progressively closer to real life communications.

In each task type except peer-to-peer interactive tasks, there can be two modes for users to choose, practice mode and test mode. Before users think they are ready to complete a task, they can use the practice mode to train the communicative skills required for the task. Learners can be suggested by the system and navigated to take target language modules, perform practice mode tasks or perform test mode task, based on the learner's progress and performance.

In all types of tasks, random plan or random response generator modules can be deployed to generate and sequence random communication items for each new round within the range of goals and language materials of a task. With these modules, audio and visual elements can be presented to learners, based on: language and non-language actions the learners need to take to interact with the system; pre-set random rules (diversity, repetition rate). This mechanism can provide simulated interactions between communication counterparts, bring unpredictable to the dialogue of a communication task, and assure the training efficiency on the designated language materials with enough practice.

Pre-designed and produced UI, text, audio and video elements can be stored in a structured fashion, and linked to by target tasks database and target language database. Various “universal module creators” can be deployed to generate target language modules and interactive tasks rapidly and cost efficiently.

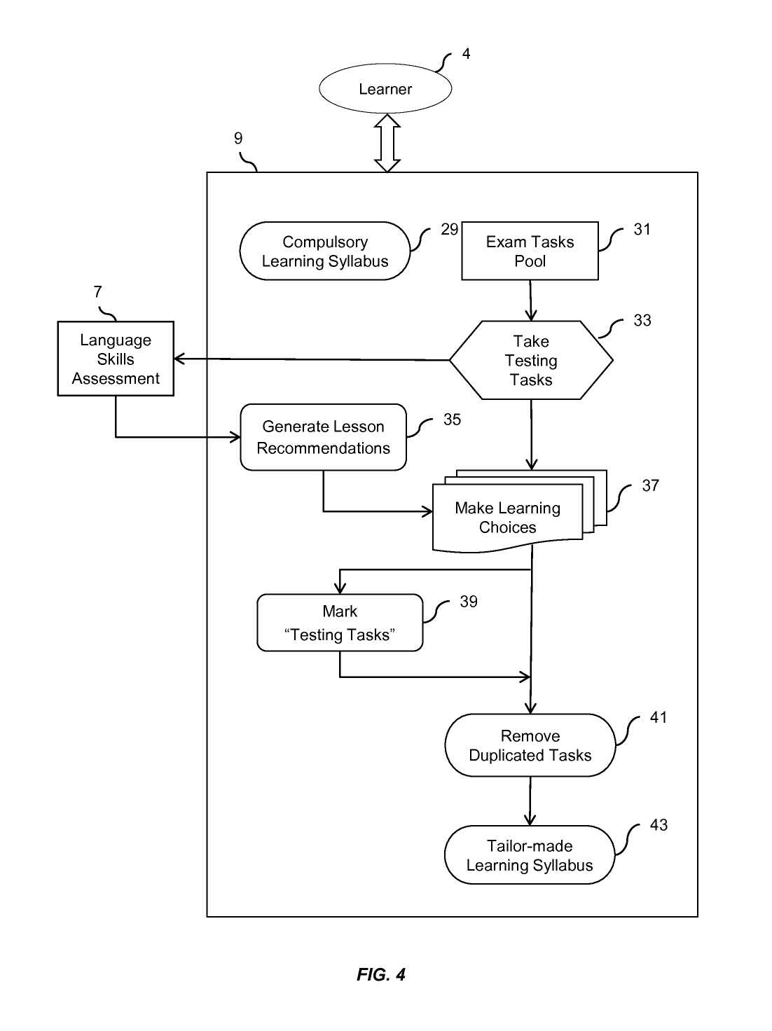

Referring to FIG. 4 is a flowchart showing a path through second-language instruction system 100 enabling users to customize learning syllabi is depicted. User management module 5 can enable a user to login to study management and support system 1 and enter learning syllabus customization 9.

Learning syllabus customization module 9 can request that the user indicate whether they have had zero experience to a second language or not: if yes, a compulsory learning syllabus 29 can be generated; if no, learning syllabus customization module 9 can request that the user choose tasks from exam tasks pool 31. For example, users can choose exam tasks that they believe they will be able to complete successfully. Learning syllabus customization module 9 can also enable users to bypass performing exam tasks, and proceed directly to make learning choices 37, for example if the user has recently finished a previous learning syllabus.

Exam, or testing, tasks can be the same as the core tasks for each lesson, exact that learners can be given only one chance to perform the tasks. Learners can be evaluated based on their mistakes and weaknesses displayed while performing the task to determine whether the learner has passed the exam or not.

Once the exam tasks are chosen, learning syllabus customization module 9 can enable the user to take testing tasks 33. After the exam is finished, the result is transferred to language skills assessment module 7 for evaluation and assessment. Language skills assessment module 7 can provide assessment results enabling learning syllabus customization module 9 to generate lesson recommendations 35. Learning syllabus customization module 9 can then generate a finalized tailor-made learning syllabus 43. Learning syllabus customization module 9 can also enable the user to add more lessons via make learning choices 37.

The make learning choices module 37 can present a learning needs survey interface, which can be generated from the target realms database 245 and the target tasks database 247 that match the learner's language level (as determined by learning progress management module 13). Learner's can make choices based on their own current or future target language needs and set a desired priority for lessons within each target realm and target task.

After learning choices are made, learning syllabus customization module 9 can remove duplicated tasks 43 if they exist. Learning syllabus customization module 9 can also compare the newly chosen target tasks 247 with user learning records 253 (discussed below) if they exist to find duplicates. Any duplicates will be marked “testing tasks” 39 and so when users are about to study these tasks, instead of learning the tasks again, they will be first navigated to a “test mode” of the specific task. If the users pass the tasks under “test mode,” they can go directly to the next task on their learning syllabus.

For all learners, as long as the learning syllabus is not the compulsory learning syllabus 29, the learning syllabus customization module 9 can check and remove duplicated tasks 41 if there are any, based on tasks similarity database 263 (discussed below). After all above steps are done, learning syllabus customization module 9 can generate finalized a tailor-made learning syllabus 43 for a new learning period.

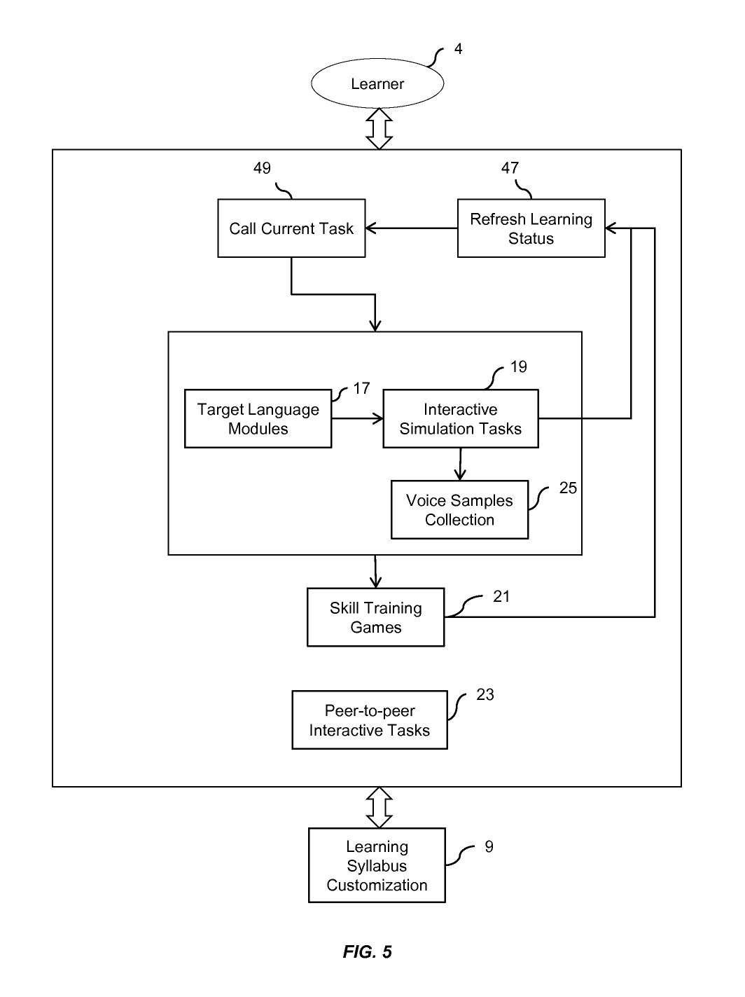

FIG. 5 is a flowchart depicting the steps of learning modules system 2. User management module 5 can enable a user to login to learning modules systems 2. Learning modules system 2 can call current task 49 to activate the current learning module based on the learner's syllabus. The current task 49 can be any interactive simulation task 19, skill training game 21, or peer-to-peer interactive task 23. Target language module 17 can be activated only when the current task is an interactive simulation task 19.

If the current task is a new interactive simulation task 19, learning modules system 2 can first activate the corresponding target language module 17 in a user interface called “training camp,” so the learner can study new language materials before completing a task. Language materials can include language parts such as sentences, words, grammar, pronunciation, culture or any other language characteristics that can be studied. After the learner has finished all of the content of the specific target language module 17, learning modules system 2 can enable the learner to exit this module and be navigated to the interactive simulation task 19. After the learner passes the interactive simulation task 19, learning modules system 2 can refresh learning status 47. If the passed task is a speaking task 57, conversational task 63, core task 69 or peer-to-peer interactive task 23, the learner's voice records can be stored via the voice samples collection module 25; however, in peer-to-peer interactive tasks, if a peer is an instructor, the instructor's voice records generally will not be stored. After each interactive simulation task 19 is done, based on the results, learning modules system 2 can automatically decide if the learner needs to practice on specific language skills, such as pronunciation, words, spelling, sentences, and writing. If so, the corresponding skill training games 21 can be activated. After the learner has finished skill training games 21, learning modules system 2 can refresh learning status 47.

If the current task is a specific skill training games 21, learning modules system 2 can navigate the learner to the corresponding skill training games 21 directly. After the learner has finished skill training games 21, the device can refresh learning status 47.

Based on system settings, peer-to-peer interactive tasks 23 can be activated after each core task 69 is finished, or a whole learning syllabus is finished.

After each time refresh learning status 47 is activated, learning modules system 2 can compare the current status with the learning syllabus of the period. If the current learning syllabus is finished, the learner can be navigated to learning syllabus customization module 9.

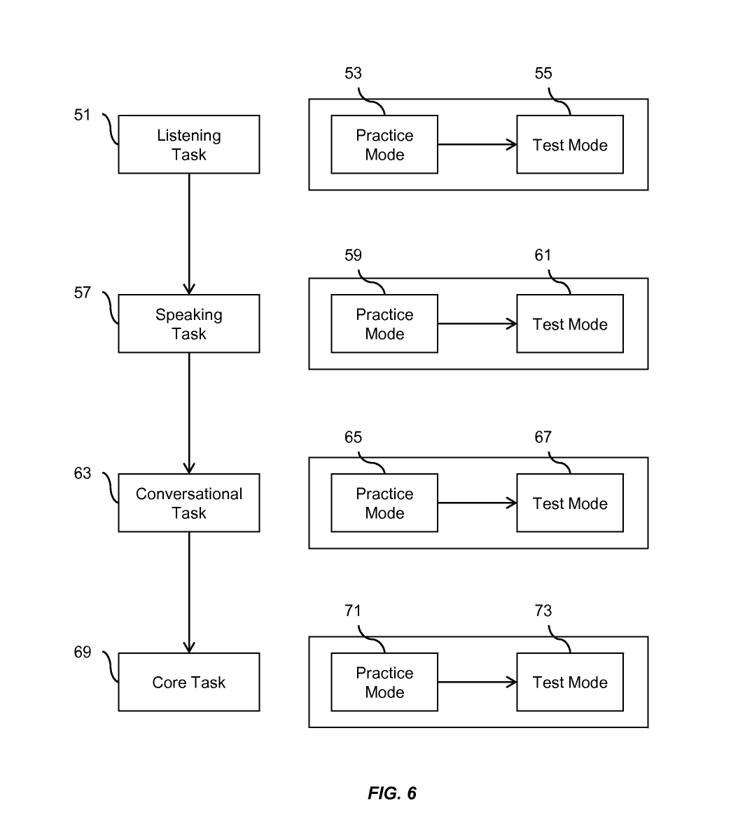

FIG. 6 is a flowchart depicting the steps for each task type of progressive interactive simulation tasks module 19. The second language instruction system can enable the users to performing listening tasks 51, followed by speaking tasks 57, conversational task 63 and finally core tasks 69. Listening tasks 51 can cover a major part of new vocabularies that will be used in core tasks 69, and learners can be trained to understand by listening to sentences in which new vocabularies are used, as well as providing required none-language correspondence. Speaking task 57 can include the vocabulary in listening task 51 as well as new vocabulary. Learners can be trained to form sentences as a speaker via both text input devices and voice recognition device. Conversational tasks 63, can include all vocabulary covered in listening task 51 and speaking task 57, as well as new vocabulary needed to form conversation needed for the conversational task 63. Learners can be trained to carry out conversations via voice recognition devices. The conversations included in each conversational task 63 can be a segment of the following core task 69, or the most difficult part of the core task 69. Core tasks 69 can be highly simulated life tasks. Core tasks 69 can have a few new vocabularies or no new vocabulary but can have new functional sentences that are not covered in the previous tasks. Learners can be trained to use language materials (newly learned or previous acquired) to fulfill core task 69. In each task, there can be two progressive modes for learners to use: the practice mode and the test mode. In practice mode, the system can enable learners do the task as many times as they want. Various forms of assistance can be provided to learners. In an embodiment, listening tasks 51 can provide a replay function. In an embodiment, speaking tasks 57 can enable users to form sentences by dragging and dropping words into the correct order and providing instant feedback.

In test mode, learners can be required to complete the task successfully based on a rubric for each task more than one time in a row in order to show that they are competent to complete the task instead of passing by random luck. No assistance can be use in test mode, and more rules and criteria can apply, such as limited time, maximum of trials before failing the task.

All of the above methods are deployed to assure that learners acquire the target language in a progressive and effective way, so as to guarantee the learning results.

FIG. 7 depicts a data flow diagram depicting modules within a listening task 51, as well as a flow of information and data stores that serve as inputs and outputs, together with user who interact with the module. For each new round of a listening task 51, the random plan generator 93 can access UI random elements 95, texts random elements 97 and audio random elements 99 in order to generate chosen elements list 84, which stores the elements and their order. The output of the random plan generator 93 can be used as one of the input sources of listening task results feedback 91.

In one embodiment, a learner location module (not shown) can provide the learner's current or previous location to random plan generator 93. The learner location module can include a global positioning system (GPS) receiver, a cellular network based location module, a Wi-Fi-based positioning system (WPS) receiver, or other locator module that is capable of determining the position of the learner's device. Random plan generator 93 can incorporate the learner's location information in order to generate random plans that vary based on the user's location. For example, if the user is near a coffee shop, the random plan may include more practice of language skills involved in ordering or serving coffee.

Once the random plan is created for a new round, task context and venue 87 elements can be initiated and visually loaded to the system platform (display device of computer, mobile device, interactive whiteboard or other applicable platforms).

Based on the chosen elements list 84 for the current round, Non-Player Character (NPC) action manager 81 can decode the random elements item by item, and convert them into NPC 83 actions which learners can see on the user interface of system platform. NPC action manager 81 can also send data to NPC audio manager 85 to determine which audio file to play. Each time NPC 83 takes an action, the status can be updated by task status monitor 89. The NPC audio manager 85 can control the audio elements (such as play, stop, or replay) and the sound can be transferred to the learner 4 via sound devices such as earphones or speakers. Each time the learner 4 receives a new sound item, he or she can try to understand the meaning of the audio message, and use listening task input manager 75 to perform an action via the agent action manager 77. The interaction media between the learner 4 and the system platform can be mouse, keyboard, touch screen, or other devices that are applicable.

Once the agent action manager 77 receives input, it can decode the action and can instruct the user agent 79 to take an action accordingly, which can then be visualized on the system platform. After user agent 79 takes an action, the NPC action manager 81 can receive the updates, and then a next item of action decoding starts, until the end of the round. Task status monitor 89 can provide data to listening task results feedback 91. Listening task results feedback 91 can compare latest data storage 119 from task status monitor 89 with related data from random plan generator 93, in order to determine when to stop the current round. For greater detail, see FIG. 11 and accompanying text. Once the current round is finished, listening task results feedback 91 can show the final results of the round, such as scores, and detailed performance statistics.

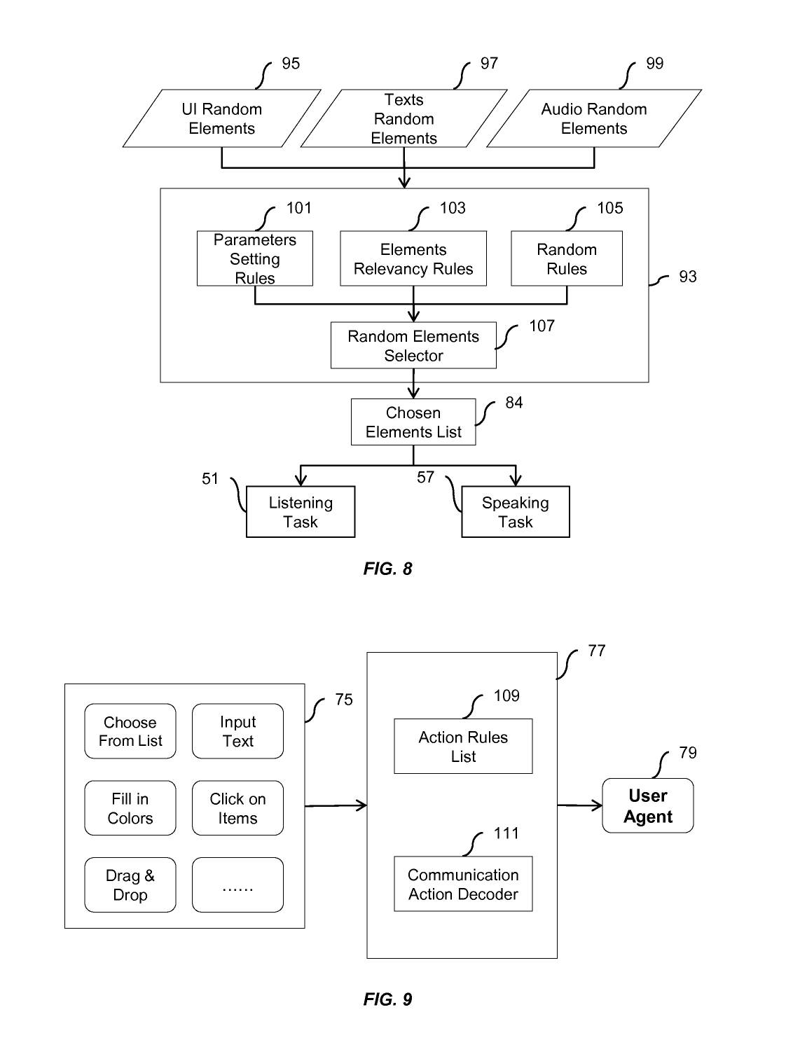

FIG. 8 depicts a data flow diagram depicting inputs and outputs to a random plan generator 93 module, as well as processing components and data stores used by listening task 51 and speaking task 57. Based on various tasks, UI random elements 95, text random elements 97 and audio random elements 99 can be stored and pre-loaded before a task module initialization. When the random plan generator module 93 is activated, parameters setting rules 101, elements relevancy rules 103, and random rules 105 can serve as criteria which random elements selector 107 uses to determine which random elements should be drawn from UI random elements 95, text random elements 97 and audio random elements 99 respectively for a whole round. The selected elements can then be stored in chosen elements list 84, which can be used as a basis to initiate the random elements when listening task 51 and speaking task 57 are initiated.

FIG. 9 depicts a data flow diagram depicting components of listening task input manager 75 and processing components within agent action manager 77, as well as input and output relations among listening task input manager 75, agent action manager 77 and user agent 79. Based on different task plans, learner 4 use different input methods to interact with the system platform, such as choosing from list, inputting text, filling in colors, clicking on items, and dragging and dropping items. Listening task input manager 75 can receive input from input devices such as mouse, keyboard, touch screen or other devices which are applicable, and convert learner 4 input into processing data and transfer to agent action manager 77. After agent action manager 77 receives the data, the system can use action rules list 109 as processing foundation, and activate communication action decoder 111 to control user agent 79 actions.

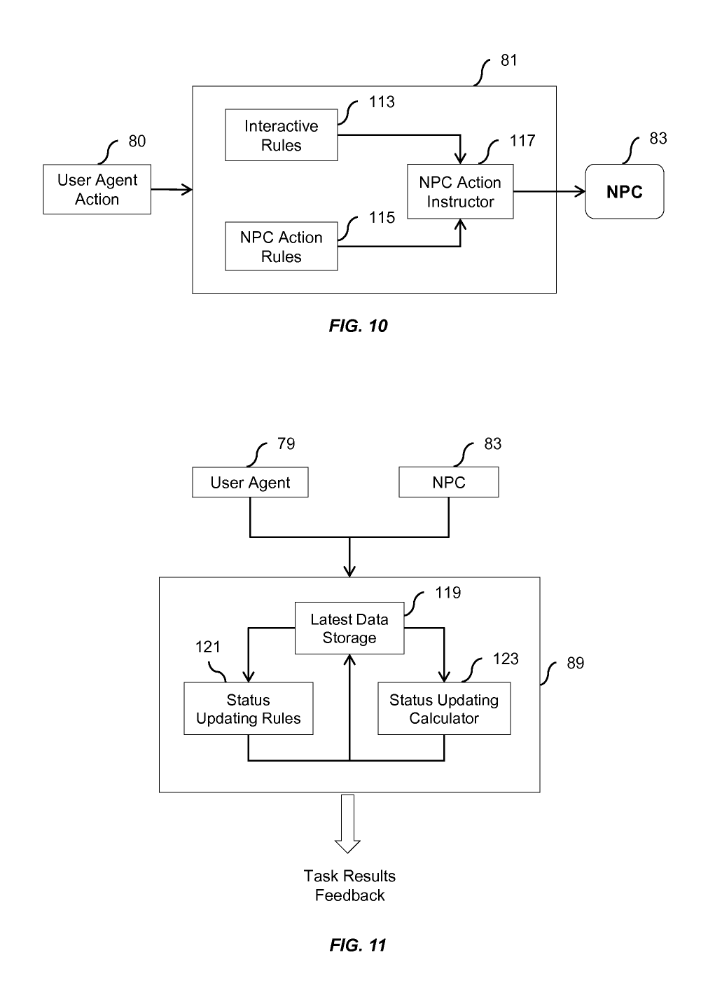

FIG. 10 depicts a data flow diagram depicting inputs and outputs to an NPC action management 81 module, as well as processing components to control NPCs within any type of interactive simulation task module. When a new user agent action 80 is input to NPC action manager 81, the NPC action manager 81 can read interactive rules 113 which can state the inter-relationship between user agent action 80 and NPC 83 actions, as well as NPC action rules 115 which can regulate all “legal” NPC 83 actions, and then run NPC action instructor 117 to control NPC 83 actions.

FIG. 11 depicts a data flow diagram depicting inputs and outputs to a task status monitor 89 module, as well processing components and data stores used by any type of interactive simulation task modules, together with messages and data exchanged among them. Whenever a user agent 79 or NPC 83 generates new data, the data can be transferred to task status monitor 89. When task status monitor 89 receives a new data, it can load the latest data storage 119 and activate status updating rules 121 and status updating calculator 123, to combine new data with the latest data storage 119, and then refresh the latest data storage 119. After each time latest data storage 119 is refreshed, it can be transferred to task result feedback devices. Latest data storage 119 can store the status of the current task. Task status items stored can include the number of rounds the learner has completed, the number of continuously successful rounds the user has completed, and the number of items that the learner has completed in the current round.

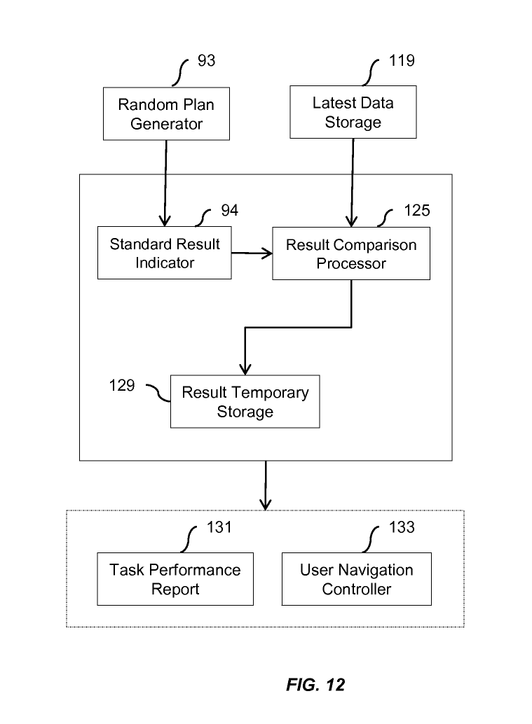

FIG. 12 depicts a data flow diagram depicting inputs and outputs to a listening task results feedback 91 module, as well as processing components and data stores used by listening task 51, together with messages and data exchanged among them. After random plan generator 93 creates a random plan for a new round and input to listening task results feedback 91, a corresponding standard result can be created by standard result indicator 94. When users are completing the task, each time the latest data storage 119 is updated, the data can be transferred to listening task results feedback 91, and the result comparison processor 125 can compare data from the two resources, including standard result indicator 94 and latest data storage 119, to generate or update the task result data. Each time the task result is updated, it can be stored in result temporary storage 129. The result comparison processor 125 can also determine whether or not the current task round is finished. If so, the result temporary storage 129 can transfer data into task performance report 131. Meanwhile, user navigation controller 133 can be activated so users can be directed to the next step, such as completing a new round of the task, suggesting to go from practice mode 53 to test mode 55, or suggesting to go to “training camp” to review corresponding target language modules 17 since the users failed the test mode 55.

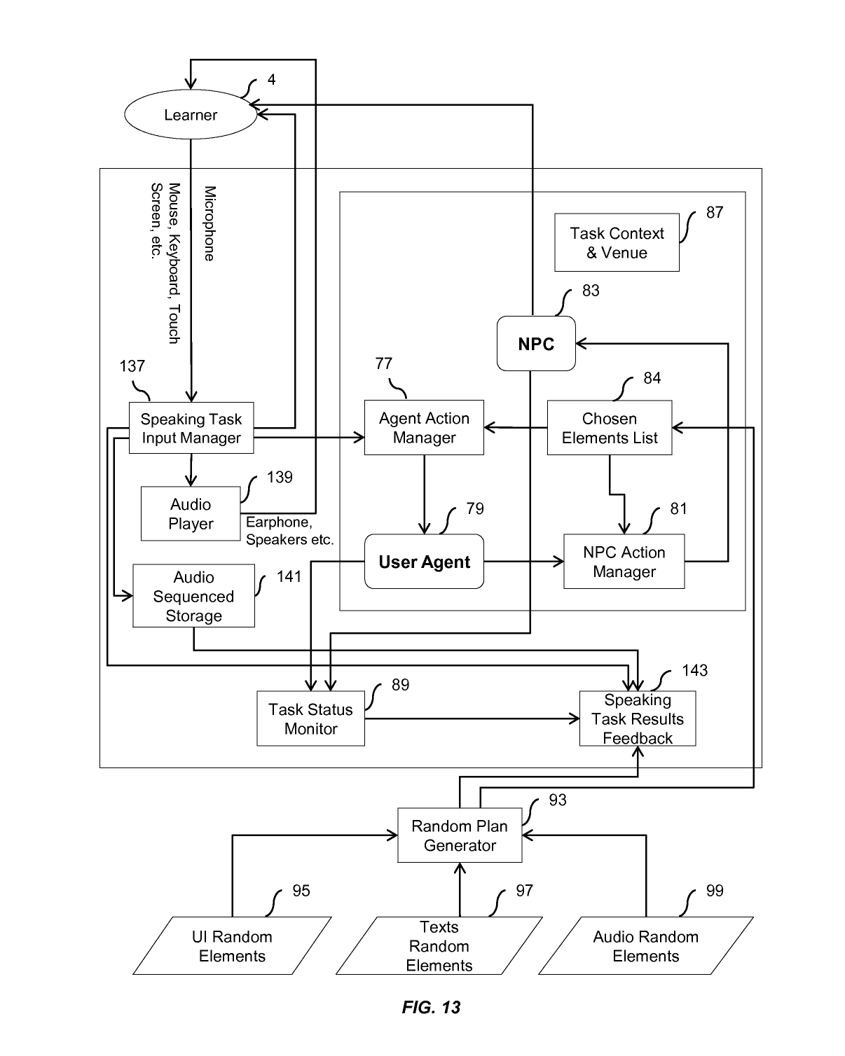

FIG. 13 depicts a data flow diagram depicting modules within a speaking task 57, as well as a flow of information and data stores that serve as inputs and outputs, together with a user who interacts with the module. The differences between listening task 51 and speaking task 57 are summarized below.

Speaking tasks 57, can utilize non-voice and voice input methods. Non-voice inputs can be presented first in order to focus on sentence forming skills. Voice input can follow non-voice inputs to focus on pronunciation and speaking at a normal speed. After NPC action manager 81 reads and decodes data from chosen elements list 84, it can control NPC 83 to react and visualize on system platform to learner 4. After agent action manager 77 receives input from speaking task input manager 137, it can read corresponding data from chosen elements list 84, and then control user agent 79 to react accordingly and visualize on system platform.

Learner 4 can input via two means: voice input through microphone and non-voice input through mouse, keyboard, touch screen or other devices. After each new item of learner 4 voice is input, an audio player 139 device is activated so learner 4 can playback the recording. Learner 4 can also listen to standard voice stored in the system to compare and imitate.

After each new voice input is submitted, it can be added to the audio sequenced storage 141. At the end of each round of a task, learner 4 can replay the entire audio sounds learner 4 made through the task, as well as listen to the standard sounds of the round of a task.

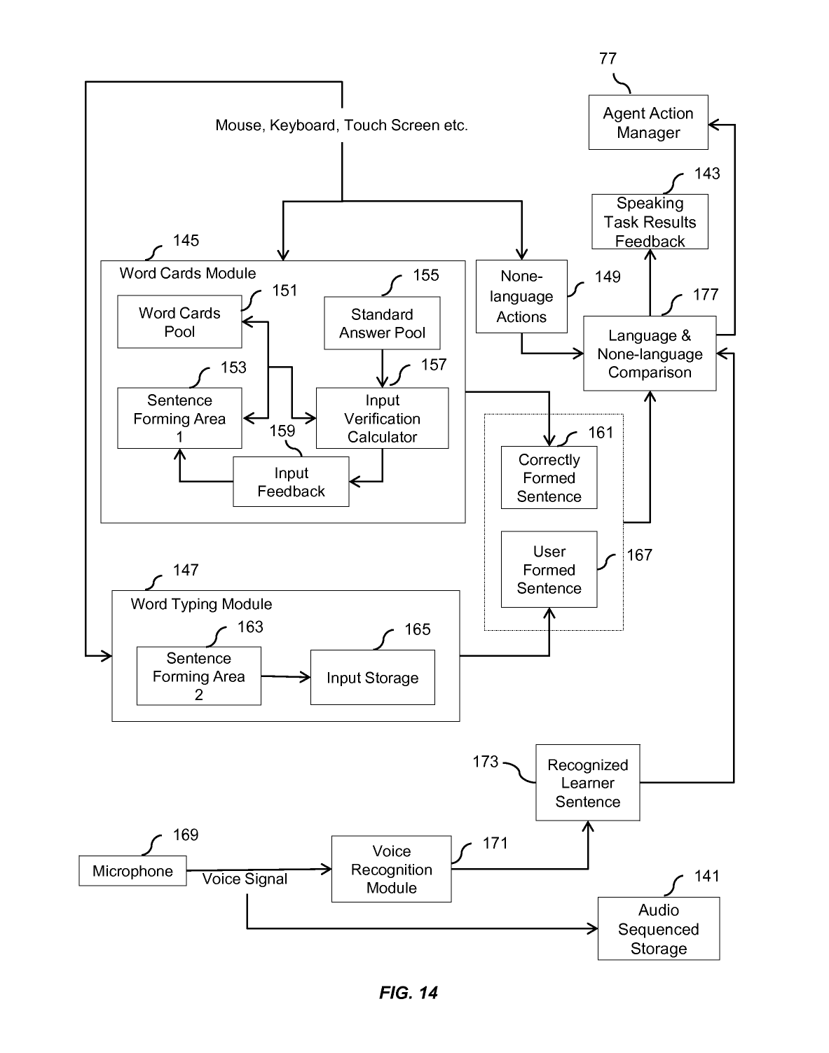

FIG. 14 depicts a data flow diagram depicting inputs and outputs to a speaking task input manager 137 module, as well as processing components and data stores used by a speaking task 57, together with messages and data exchanged among them. A mouse, keyboard, touch screen, other input devices, or a combination thereof can be used to give non-voice input. Microphone 169 (built-in or peripheral) can be used to give voice input. Within the speaking task input manager 137 device, there are two modes, one applies to speaking task 57 practice mode 59, and the other applies to test mode 61.

For practice mode 59, there can be two types of non-voice language input: word cards module 145 and word typing module 147, neither of which are applicable to test mode 61. For a new speaking task 57, if both types are used, word cards module 145 can always apply before word typing module 147.

Within word cards module 145, there can be a word cards pool 151, which can contain and show optional cards with words that could be used to form a correct sentence. Cards showed to learner 4 are more than words needed to form a sentence, so learner 4 should not only know the words order to form a sentence, but also what words should be chosen to form the sentence. There is a sentence forming area 153, which is for learner 4 to drop the chosen word cards to form a sentence. After a sentence is submitted, input verification calculator 157 can compare the input with standard answer pool 155 on the specific item. If learner's 4 input is correct, it can transfer the data into correctly formed sentence 161; if not, an input feedback 159 is called to visualize the correct cards and wrong cards. Incorrect cards can still be enabled to move out and move around, whereas correct cards can be locked in place. Other ways of indicating correct cards can also be applicable. This process can continue until learner 4 has formed a correct sentence.

Within word typing module 147, there is a sentence forming area 163, which learner 4 can use to type a sentence into the system. The sentence can be temporarily stored in input storage 165 without verification. After each new sentence is stored, user formed sentence 167 can be updated to store all sentences learner 4 has entered.

For test mode 61, only one type of language input can be applied—voice input. Voice recognition module 171 communicates with microphone 169 (built in or peripheral) to pick up voice signal as input, and can convert it into a text form of recognized learner sentence 173. Each voice item of a sentence can be added and stored in audio sequenced storage 141.

Based on various speaking tasks 57, non-language actions 149 can be applied, such as dragging-and-dropping a visual object or filling in colors. After non-language actions 149 are complete, language and non-language comparison 177 can be activated to compare two sources of input: correctly formed sentence 161 versus non-language actions 149; user formed sentence 167 versus non-language actions 149; or recognized learner sentence 173 versus non-language actions 149. After the comparison, the results can be transferred to speaking task results feedback 143, and agent action manager 77 can be activated.

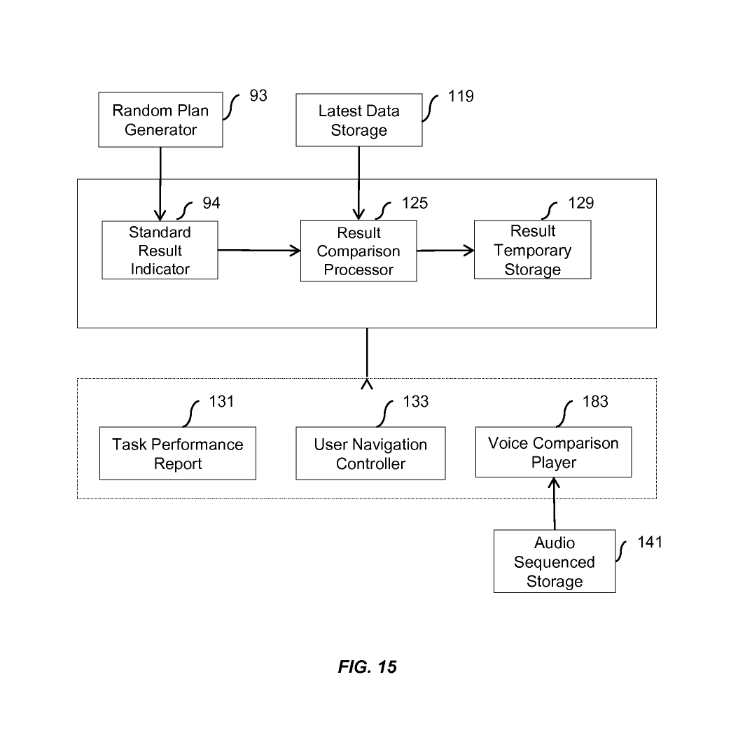

FIG. 15 depicts a data flow diagram depicting inputs and outputs to a speaking task results feedback 143 module, as well as processing components and data stores used by speaking task 57, together with messages and data exchanged among them. Speaking task results feedback 143 can run in a similar way to listening task results feedback 91, with an added voice comparison player 183 as a result output, which can combine audio sequenced storage 141 that stored learner 4 voice inputs of the entire task with the corresponding standard audio sounds stored in standard result indicator 94. In this way, learner 4 can replay all of the voice sentences in a round so as to review and practice the sentences that need improvement.

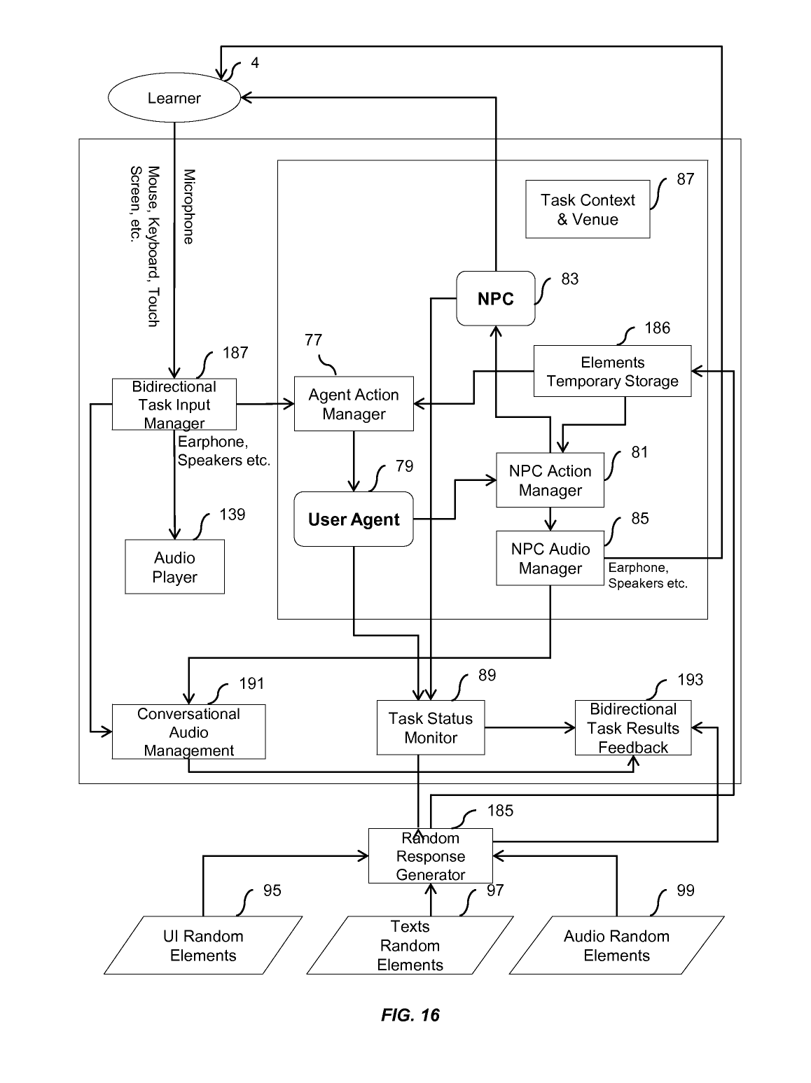

FIG. 16 is a data flow diagram depicting modules within a conversational task 63, as well as a flow of information and data stores that serve as inputs and outputs, together with a user who interacts with the module. Since the conversation between learner 4 and NPC 83 can be changing as the task progresses, instead of generating a random plan for an entire round of a task, the random response generator 185 can generate random elements step by step. Once a new set of random elements are generated, random response generator 185 can transfer the data to elements temporary storage 186 so it can be read and used by NPC action manager 81 and agent action manager 77. Random response generator 185 can also transfer the data to bidirectional task results feedback 193 to provide standard results for comparison.

The data stored in elements temporary storage 186 can be called and used by both agent action manager 77 when learner 4 needs to take action via a user agent 79, and NPC action manager 81 when one or more NPCs 83 take action.

The bidirectional task input manager 187 receives voice input via microphone as well as non-language input via mouse, keyboard, touch screen, or other devices.

In practice mode 65, audio player 139 can be activated after each item of learner 4 voice input is submitted, so learner 4 can replay what learner said as well as listen to standard audio sound to imitate and practice. In test mode 67, this device can be deactivated.

The conversational audio management module 191 can receive voice audio data from bidirectional task input manager 187, which can be the dialogue made by learner 4, and the data can be added into a conversational sequence. NPC audio manager 85 can send NPC 83 audio data and standard user-role audio data to conversational audio management 191 in a conversational sequence as well. When a whole round of tasks is finished, all data stored in conversational audio management 191 can be transferred to bidirectional task results feedback 193, so learner 4 can replay the entire task audio in the order of the conversation took place.

Other components in FIG. 16 that are not discussed in this section can function in a similar manner to those described in previous diagrams.

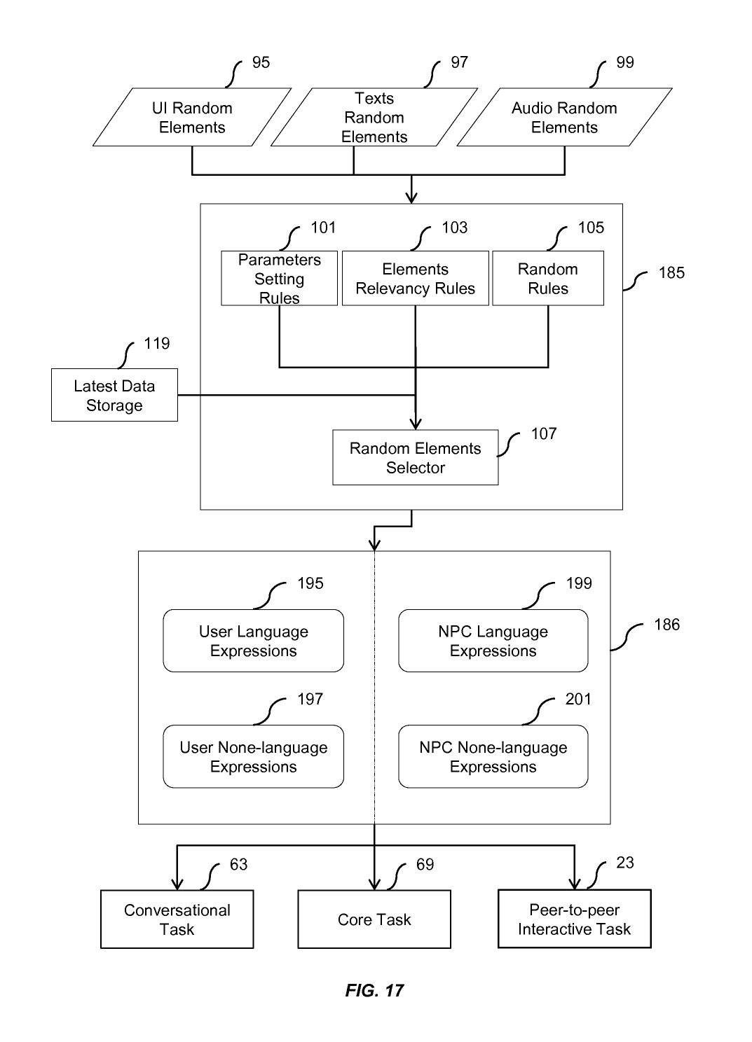

FIG. 17 depicts a data flow diagram depicting inputs and outputs to a random response generator 185 module and elements temporary storage 186 module, as well as processing components and data stores used by conversational task 63, core task 69 and peer-to-peer interactive task 23, together with messages and data exchanged among them.

The primary difference between random plan generator 93 and random response generator 185 lies in the following aspects. Instead of generating random elements for a whole round of a task, UI random elements 95, texts random elements 97 and audio random elements 99 data can read each time before a new set of conversational action can take place. In addition, besides parameters setting rules 101, elements relevancy rules 103 and random rules 105, latest data storage 119 can give input to random elements selector 107 as well, which affects the random elements selection on a statistical basis. Latest data storage 119 is a component in task status monitor 89 module, and the data can be transferred to random response generator 185 each time a previous set of conversations is finished.

The output of random response generator 185 can be stored in elements temporary storage 186, which can include four storage components: user language expressions 195, user non-language expressions 197, NPC language expressions 199 and NPC Non-language expressions 201. These can be used in conversational tasks 63, core tasks 69 and peer-to-peer interactive tasks 23.

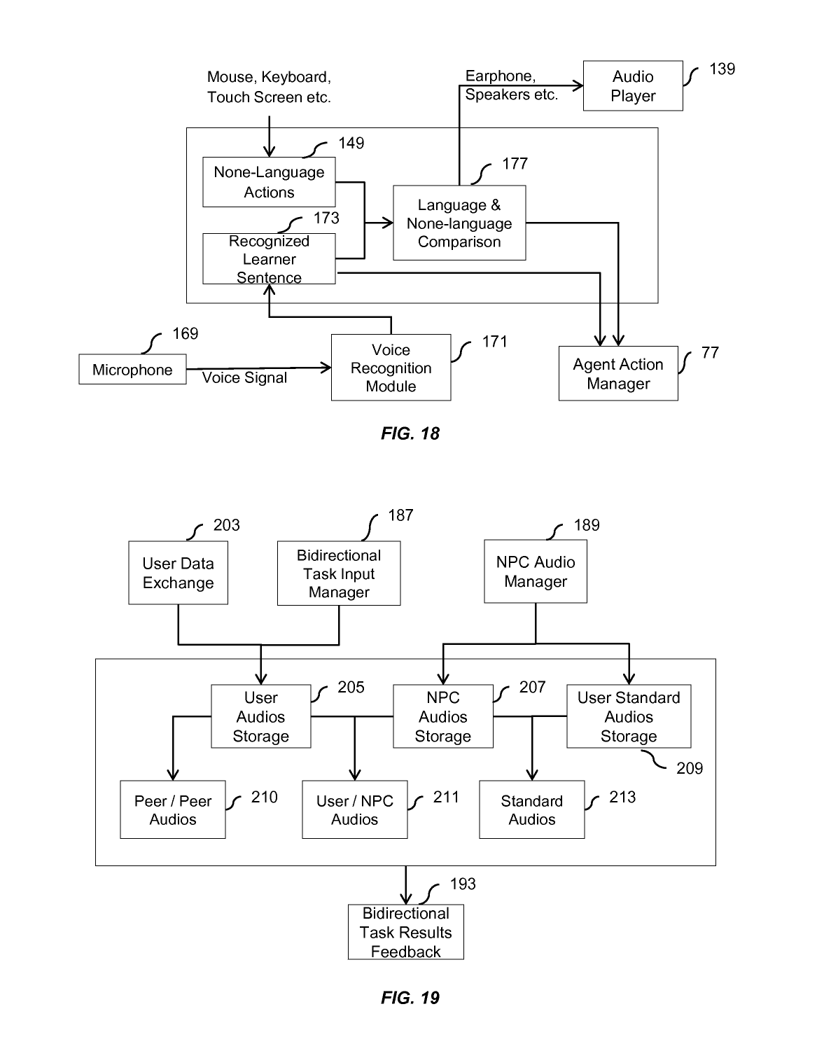

FIG. 18 depicts a data flow diagram depicting inputs and outputs to an bidirectional task input manager 187 module, as well as processing components and data stores used by conversational tasks 63 and core tasks 69. Because the conversational tasks 63 and core tasks 69 are both dialogue based, the language input is only via voice, and no visual form of sentence can be involved. The output of voice recognition module 171 is recognized user sentence 173 in text form so it can be processed by agent action manager 77.

Non-language actions 149 can be needed based on various task plans, such as filling in colors, choosing items, and a combination thereof. Whenever there are voice input and non-language input, language and non-language comparison 177 can be activated to verify if the two inputs match. If yes, the data can be transferred to agent action manager 77. If not, audio player 139 can be activated so NPC 83 can “double check” what the learner 4 wants to do. The audio information played can be in a natural form of conversation using target language, such as “Excuse me, which color do you want?” if, for example, the mismatched information is color.

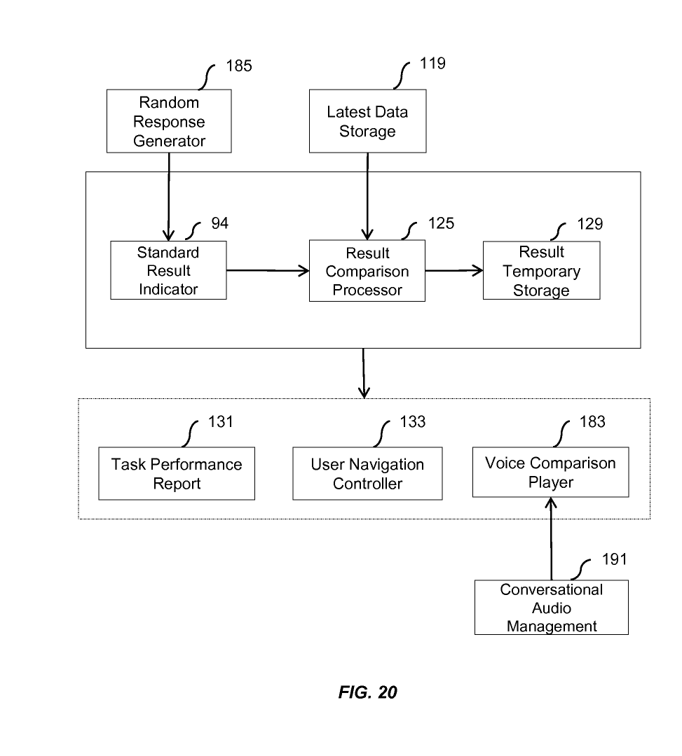

FIG. 19 is a data flow diagram depicting inputs and outputs to a conversational audio management 191 module, as well as processing components and data stores used by conversational task 63, core task 69 and peer-to-peer interactive Task 23.

For conversational task 63 and core task 69, the user audio storage 205 input can be from bidirectional task input manager 187. NPC audio manager 189 transfers NPC 83 audio into NPC audio storage 207 and user-role standard audio into user standard audio storage 209. This audio can be added to storage step by step along the completion of a task in a dialogue order. The user standard audio file added can be in correspondence with user audio. In other words, the same sentence which is pre-recorded and stored as a standard audio sentence. Whenever new audio data is added, user NPC audio 211 and standard audio 213 can be updated to reflect the latest audio in a dialogue order. When a round of task is finished, the final user/NPC audio 211 and standard audio 213 can be transferred to bidirectional task results feedback 193 so that learner 4 can replay the entire dialogue both he/she had with NPC, and the standard user-role audios versus NPC audio.

For peer-to-peer interactive task 23, the user audio storage 205 can be from user data exchange 203. When stored, the audio can be marked as learner A and learner B, in order to separate each role. Each time there is a new voice input in user data exchange 203, the user audio storage 205 can be updated, as well as peer-to-peer audio 210. Peer-to-peer audios 210 can be processed to reflect the latest audio in a dialogue order. When a round of task is finished, the final peer-to-peer audio 210 can be transferred to bidirectional task results feedback 193 so both learners can replay the entire dialogue on their system platform terminal.

Audio files can be stored in MP3, MP4, AAC, FLAC, or any other format capable of storing audio.

FIG. 20 is a data flow diagram depicting inputs and outputs to a bidirectional task results feedback 193 module, as well as processing components and data stores used by conversational task 63, core task 69 and peer-to-peer interactive task 23, together with messages and data exchanged among them. The difference between speaking task results feedback 143 and bidirectional task results feedback 193 lies in these aspects. The standard results can be updated after each time random response generator 185 generates a new set of data and the voice comparison player 183 can read data from conversational audio manager 191 after each round of a task is finished.

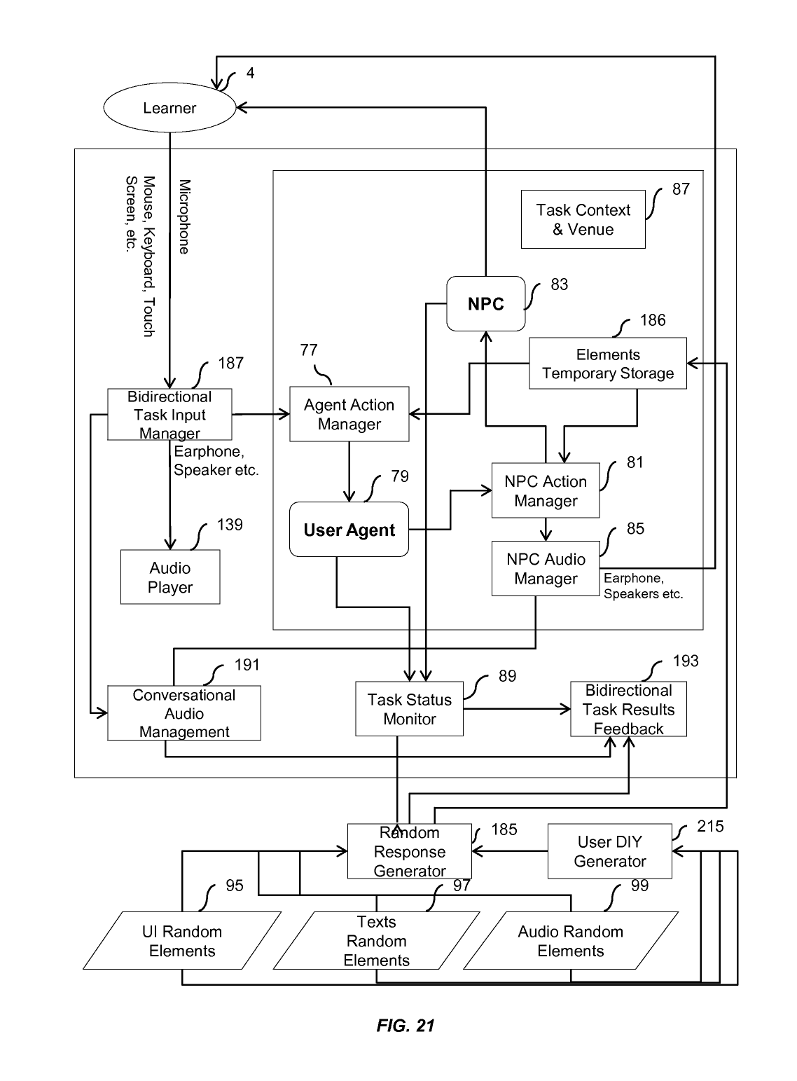

FIG. 21 is a data flow diagram depicting modules within a core task 69, as well as a flow of information and data stores that serve as inputs and outputs, together with a user who interacts with the module. The primary difference between core task 69 module and conversational task 63 module is, for core task 69, before a task is initiated, learner 4 can use the device user DIY generator 215 to customize random elements that the user-role can control and choose. With this device learner 4 can create a core task 69 that can simulate as close to a real life task possible. Based on various task plans, random elements can include data from UI random elements 95 and text random elements 97, and the corresponding audio random elements 99 can be loaded accordingly as applied.

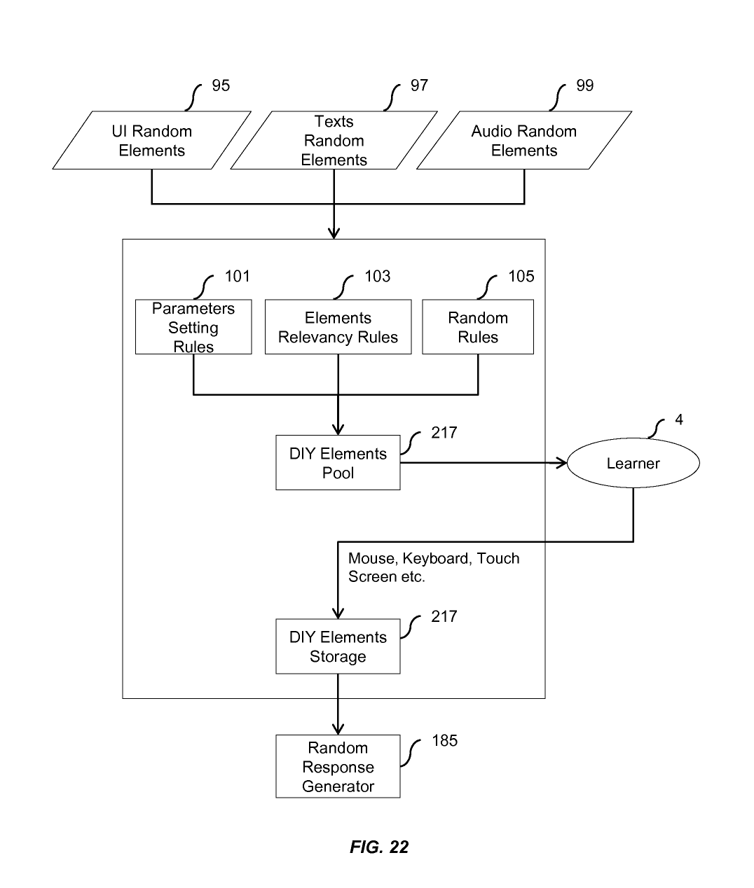

FIG. 22 is a data flow diagram depicting inputs and outputs to a user DIY generator 215 module, as well as processing components and data stores used by core task 69 and peer-to-peer interactive task 23, together with messages and data exchanged among them. User DIY generator 215 can enable learners to set preferences for customizable user interface elements. Customizable UI elements can be dependent on the specific tasks to be solved. For example, a learner can be able to customize the possible budget figures for a purchasing task, or a list of foods to include on a checklist of food preferences. Applicable UI random elements 95 and texts random elements 97 can be loaded first. Based on the parameters setting rules 101, DIY elements pool 217 can be generated in an organized way for learner to make a customized selection. When making selections, elements relevancy rules 103 and random rules 105 can be activated to assure the DIY plan is valid and has a desired statistical balance. In one embodiment, a learner can be required to choose each of the available options at least once. For example, if a clothing purchase task requires four different types of clothes and six different colors for a learner to say in a dialogue, the DIY generator 215 can prompt the learner for valid choices. In this example, if the first selection is a blue t-shirt, the learner can be required to make a following selection that is not blue, or a t-shirt, until all of the types of clothes and/or colors have been chosen at least once. After a selection is finished for a round, the chosen random elements are stored in DIY elements storage 217. DIY elements storage 217 can be input into random response generator 185 so the core Task 69 module can continue to process NPC random elements plan.

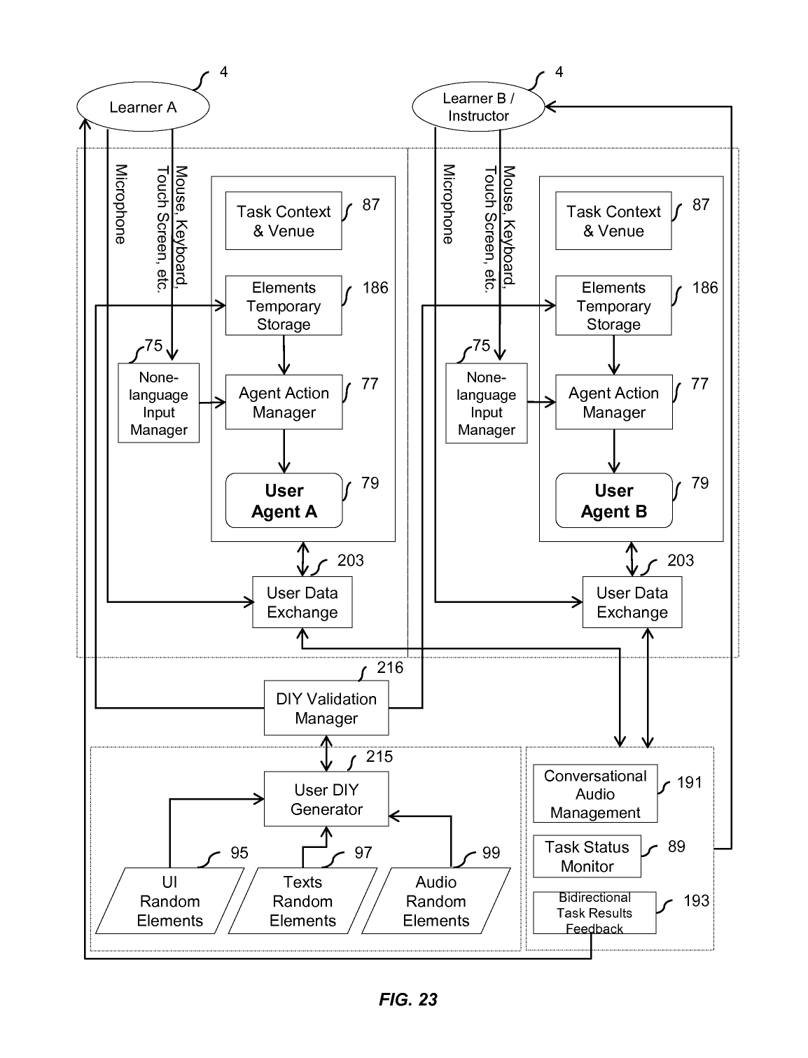

FIG. 23 is a data flow diagram depicting modules within a peer-to-peer interactive task 23, as well as a flow of information and data stores that serve as inputs and outputs, together with users who interact. Since this is a person-to-person interaction, there can be more than one person involved; for example, one can be a learner, the other can be a learner or an instructor.

Before a task starts, the peers can use user DIY generator 215 to choose random elements based on their needs or interests. After these are submitted to the system platform, DIY validation manager can be activated to check the random elements to assure the chosen items from each party match with task goals and needs. If not, information feedback can be transferred to each party's system platform interface. Suggestion of changes can also apply. If all random elements are valid, a new round of peer-to-peer interactive task 23 can start.

The parties can use microphones for audio input, and the audio can be transferred directly to the peer party via user data exchange 203. There can be non-language input involved depending on the task plans. The parties can use mouse, keyboard, touch screen or other applicable device to input data, and the data can be processed by none-language input manager 75. When agent action manager 77 receives data from none-language input manager 75, it can decode and control user agent 79 to react. User agent 79 action can be shown on each user's system platform interface via user data exchange 203, yet the UI elements can be different based on the task plans. Particularly since more than one peer can be playing different roles in the task, the user interface and information revealed to each party can be different.

Each time two parties exchange data, conversational audio management 191, task status monitor 89 and bidirectional task results feedback 193 can be updated accordingly, until a round of task is finished. Bidirectional task results feedback 193 can transfer data to each party's system platform interface to view their final results. Both visual and audio results can be applied.

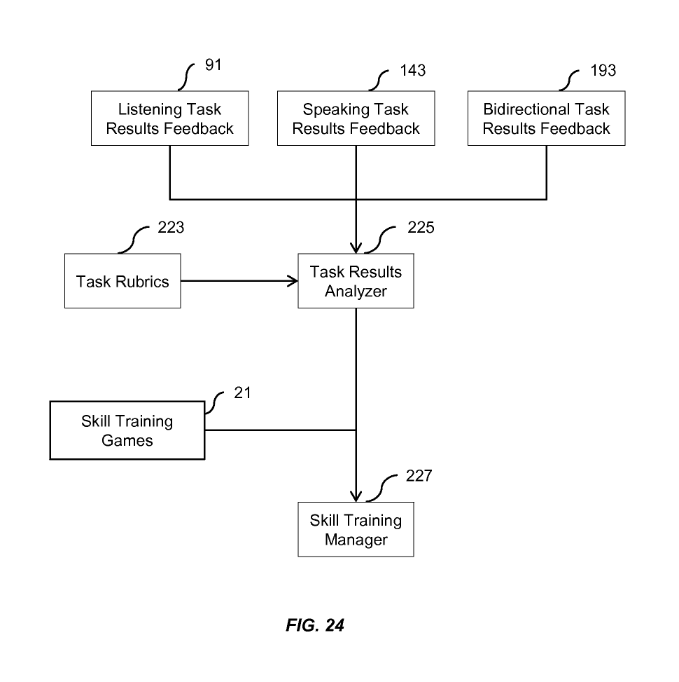

FIG. 24 is a data flow diagram depicting inputs and outputs to choose and activate skill training games 21 modules, as well as processing components and data stores used in the device. After every learning task is finished, listening task results feedback 91, speaking task results feedback 143 or bidirectional task results feedback 193 can input data to task results analyzer 225. Task results analyzer 225 can process analysis based on corresponding task rubrics 223, and send analysis results to skill training manager 227. Skill training manager 227 can control which skill training games 21 need to be activated if the analysis results indicate that learner 4 needs intensive language skill training. The skill training games 21 can cover various specific language skills, such as pronunciation, spelling, reading, writing, and forming sentences.

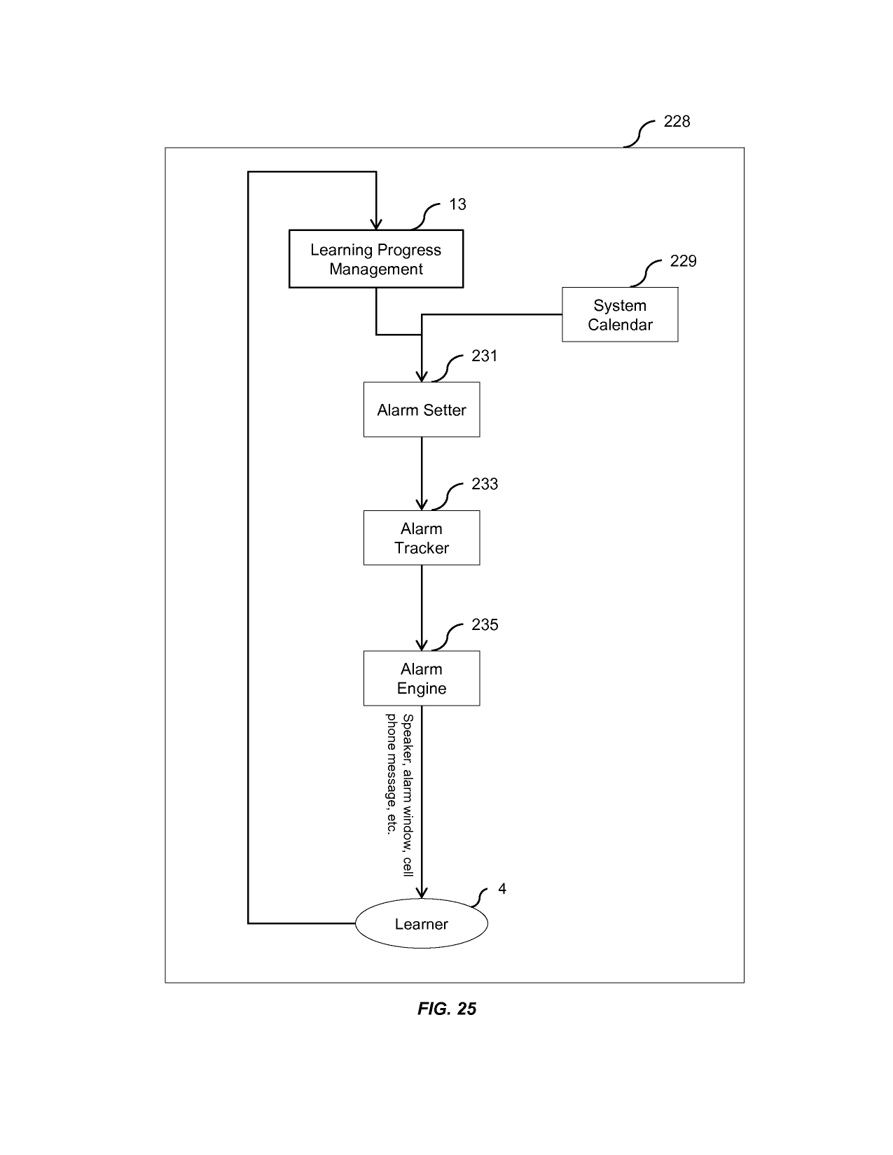

FIG. 25 is a data flow diagram depicting a procedure for a learning tasks alarm system 228, as well as a flow of information and data stores that serve as inputs and outputs, together with users who interact with the module. The learning tasks alarm system can be built into the user management module 5. It can enable for users to manage their learning schedule. Each time the learning tasks alarm system 228 runs, learning progress management 13 data can be accessed. Learning tasks alarm system 228 can interact with one or more system calendar 229, which can be provided by various user system platform devices. Depending on the individual learner's devices, learning tasks alarm system 228 can populate system calendar 229 with pending alarm events via alarm setter 231. Learning tasks alarm system 228 can also be configured to send scheduled short messages to a learner's device of choice via a mobile, email, or other data service carrier if applicable. Users can use mouse, keyboard, touch screen or other applicable device to input their desired settings into the system, such as date, time, interval, frequency, reminding time.

Whenever alarm setter 231 is updated, alarm tracker 233 can be updated accordingly. If there are no activated alarm settings, alarm tracker 233 can be deactivated. Otherwise, alarm tracker 233 can update to keep a record of all outstanding alarms.

When an alarm needs to be shown or sent onto users' device interface, alarm engine 235 can be activated. Various forms of alarm messages can be sent to users based on different devices and users' settings, such as alarm sounds through speakers and earphones, alarm popup windows, and cell phone messages via user's cell phone service carrier.

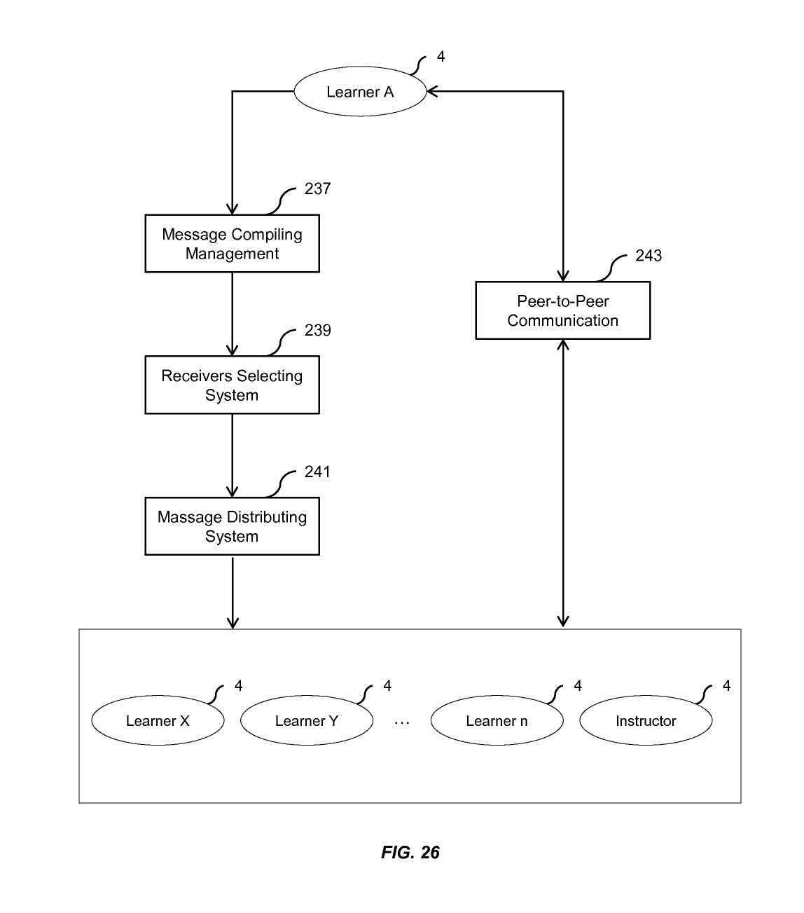

FIG. 26 is a data flow diagram depicting procedure for learners to find peer-to-peer counterpart for implementing interactive task 23, as well as processing components and data stores that serve as inputs and outputs together with users who interact. When a learner 4 needs to complete a peer-to-peer interactive task 23, learner 4 can first use the peer-to-peer interactive task 23 module to initiate an invitation in order to find a counterpart. The peer-to-peer interactive task module 23 can have a message compiling management component 237, which learner 4 can use to edit learner's invitation contents. Based on the initiating learner's learning progress data in learning progress management 13 and the user management 5 data, a potential recipients list can be generated by the system and pre-stored in receivers selecting system 239. After the invitation content is finished, learner 4 can use receivers selecting system 239 to single out target counterparts. Message distributing system 241 can be activated after learner 4 finishes choosing target counterparts. As an output of message distributing system 241, all target recipients can receive the invitation, except the recipients who have disabled the choice of “receiving peer-to-peer task invitation.” The recipients who receive an invitation can use peer-to-peer communication 243 tools to set up schedule with the invitation initiator. The learning tasks alarm system 228 can be activated once a schedule is set up, and pending alarm events can be added to each learner's calendar.

When participating in peer-to-peer interactive tasks 23, users can see each other via video capture equipment. For tasks that involve users participating in different roles, users can be given different information, and the users' screens can display different venues. For example, a peer-to-peer interactive task 23 can involve a fruit buyer and a fruit seller. The fruit buyer can see the outside of the fruit booth and the fruit seller can see the inside. Each screen can be multifunctional, with a window of video image, and other part of the screen showing the venue image and other UI components needed to participate in the task.

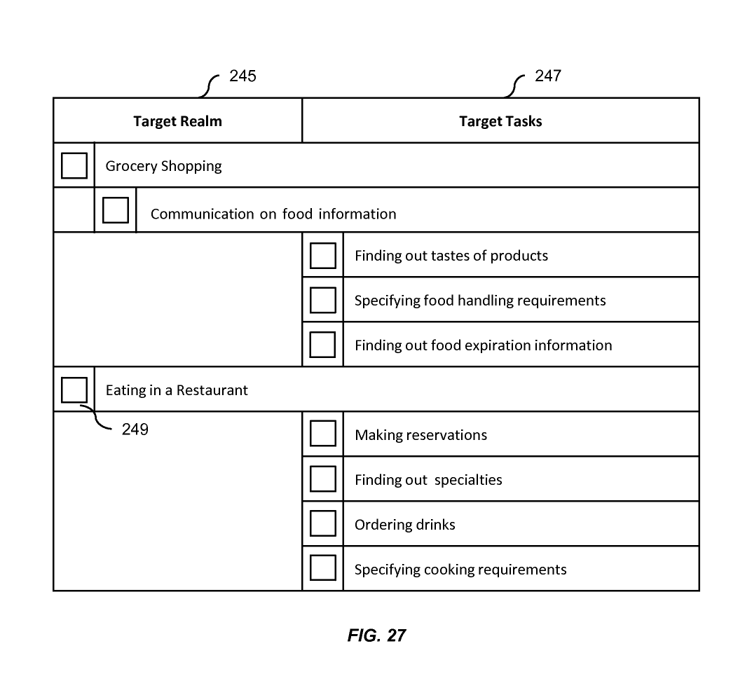

FIG. 27 is a sample user interface that depicts the layout and sample contents of target realms 245 and target tasks 247 for users to choose when users make learning choices 37. Target realms 245 and target tasks 247 data can be stored in target tasks database 257. Target realms 245 are learning topics that can be created based on massive “target learners learning needs survey.” Target tasks 247 can be specific learning tasks originated from massive “target learners learning needs survey” yet filtered and redesigned into teaching tasks. In this second language instruction system, all target tasks 247 can be planned, designed, developed and built into the system, as the minimum learning unit for users to choose. Check box 249 can enable users to mark their choices.

Second language instruction must possess the function of “teaching.” According to disclosed embodiments, the teaching functions can include, but are not limited to: designed learning content which can be segmented into levels and lessons rather than “learning with flow”; designed frequency and progressive levels of learning modules; designed NPC reactions which meet the learning level; and recording the performance of a user in a lesson and providing hints or feedbacks as needed. In the disclosed embodiments, the designed simulation teaching tasks can imitate the factors of real life communication tasks, in order to create a platform for learners to “learn through doing,” rather than learning through mechanical drills.

If not carefully designed, even if it simulates real life, an instruction system may not be effective to learners with different language levels and learning demands. For this reason, disclosed embodiments possess an instructional content customization function. Customized instructional content can reduce learner's study time, increase pertinence and interests of a study.

The computer, computing device, tablet, smartphone, server, and hardware mentioned herein can be any programmable device(s) that accepts analog and digital data as input, is configured to process the input according to instructions or algorithms, and provides results as outputs. In an embodiment, the processing systems can include one or more central processing units (CPUs) configured to carry out the instructions stored in an associated memory of a single-threaded or multi-threaded computer program or code using conventional arithmetical, logical, and input/output operations. The associated memory can comprise volatile or non-volatile memory to not only provide space to execute the instructions or algorithms, but to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the claims.

In other embodiments, the processing system or the computer, computing device, tablet, smartphone, server, and hardware, can include various engines, each of which is constructed, programmed, configured, or otherwise adapted, to autonomously carry out a function or set of functions. The term engine as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware that execute an operating system, system programs, and application programs, while also implementing the engine using multitasking, multithreading, distributed processing where appropriate, or other such techniques.

Accordingly, it will be understood that each processing system can be realized in a variety of physically realizable configurations, and should generally not be limited to any particular implementation exemplified herein, unless such limitations are expressly called out. In addition, a processing system can itself be composed of more than one engine, sub-engines, or sub-processing systems, each of which can be regarded as a processing system in its own right. Moreover, in embodiments discussed herein, each of the various processing systems can correspond to a defined autonomous functionality; however, it should be understood that in other contemplated embodiments, each functionality can be distributed to more than one processing system. Likewise, in other contemplated embodiments, multiple defined functionalities can be implemented by a single processing system that performs those multiple functions, possibly alongside other functions, or distributed differently among a set of processing system than specifically illustrated in the examples herein.

Various embodiments of devices, systems and methods have been described herein. These embodiments are given only by way of example and are not intended to limit the scope of the invention. It should be appreciated, moreover, that the various features of the embodiments that have been described can be combined in various ways to produce numerous additional embodiments. Moreover, while various materials, dimensions, shapes, configurations and locations have been described for use with disclosed embodiments, others besides those disclosed can be utilized without exceeding the scope of the invention.

Persons of ordinary skill in the relevant arts will recognize that embodiments may comprise fewer features than illustrated in any individual embodiment described above. The embodiments described herein are not meant to be an exhaustive presentation of the ways in which the various features may be combined. Accordingly, the embodiments are not mutually exclusive combinations of features; rather, embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted. Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Furthermore, it is intended also to include features of a claim in any other independent claim even if this claim is not directly made dependent to the independent claim.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of Section 112, sixth paragraph of 35 U.S.C. are not to be invoked unless the specific terms “means for” or “step for” are recited in a claim.

What is claimed is:

1. A second language instruction system enabling a user to learn a second language through one or more life-like scenarios in a virtual world, comprising:
a computing device in electrical communication with a server via a network, the computing device including:
a language skills assessment module configured to assess the second language abilities of the user;
a customization module configured to receive one or more scenario preferences of the user and to generate a customized learning syllabus at least partially based on the assessed second language abilities of the user, wherein the customized learning syllabus includes an interaction portion in which the user is required to navigate around a virtual world to interact with virtual characters in one or more life-like scenarios selected based on the received one or more scenario preferences of the user; and
a virtual venues management module configured to download the one or more life-like scenarios from the server to the computing device on demand, and remove the one or more life-like scenarios from the computing device after completion, for the purpose of minimizing the amount of data stored on the computing device.

2. The system of claim 1, wherein the customized learning syllabus further includes a non-life-like portion.

3. The system of claim 2, wherein the non-life-like portion is generated based on the at least one of the received one or more scenario preferences of the user, observations made during of completion of the one or more life-like scenarios, and a combination thereof.

4. The system of claim 2, wherein the user can switch between the life-like portion and the one or more non-life-like scenarios of the customized learning syllabus.

5. The system of claim 1, wherein the customized learning syllabus includes at least one of a listening portion, a speaking portion, a conversational portion, and a core task portion.

6. The system of claim 5, wherein the core task portion includes at least one of greeting another person, being introduced to another person, introducing another person, buying food, buying clothes, eating in a restaurant, making an appointment, changing an appointment, asking for directions, giving directions, specifying destinations, and handling an emergency.

7. The system of claim 5, wherein each portion of the customized learning syllabus includes a testing portion.

8. The system of claim 1, wherein the customization module is further configured to provide a compulsory learning syllabus when the user has no experience in the second language.

9. The system of claim 1, wherein the customization module is configured to identify duplicate portions in the customized learning syllabus.

10. The system of claim 1, wherein the customization module is further configured to identify portions that the user has already completed.

11. The system of claim 1, further comprising a hint and assistance module configured to provide information to the user regarding a portion of the customized learning syllabus.

12. The system of claim 1, further comprising a user management module configured to store personal information for the user, including one of more user preferences for visual elements.

13. The system of claim 12, wherein the user management module is further configured to record a learning history of the user and generate feedback to the user at least partially based on the learning history.

14. The system of claim 13, wherein the learning history includes one or more observations made during of completion of the customized learning syllabus.

15. The system of claim 13, wherein the learning history further includes one or more voice samples collected from the user via a microphone.

16. The system of claim 1, further comprising a peer-to-peer interactive task module configured to enable a first user to connect with a second user to complete one or more peer-to-peer task portions.

17. The system of claim 16, wherein the peer-to-peer interactive task module is configured to match the first user with the second user at least partially based on the assessed second language abilities of the first user and the second user, and at least partially based on the received one or more scenario preferences of the first user and the second user.

18. The system of claim 16, further comprising a microphone configured to enable voice communication between the first user and the second user.

19. The system of claim 16, further comprising a camera configured to enable video communication between the first user and the second user.

20. A method of providing second language instruction through one or more life-like scenarios in a virtual world, comprising:
assessing the second language abilities of a user;
receiving one or more scenario preferences of the user;
generating a customized learning syllabus at least partially based on the assessed second language abilities of the user, wherein the customized learning syllabus includes an interaction portion in which the user is required to navigate around a virtual world to interact with virtual characters in one or more life-like scenarios selected based on the received one or more scenario preferences of the user;
downloading the one or more life-like scenarios from a server to a computing device on demand; and
removing the one or more life-like scenarios from the computing device after completion, for the purpose of minimizing the amount of data stored on the computing device.
